(19) United States
(12) Patent Application Publication
(10) Pub. No.: US 2026/0236105 A1
(43) Pub. Date: Aug. 13, 2026

(54) ELECTRONIC DEVICE AND OPERATING METHOD THEREOF

(71) Applicant: Samsung Electronics Co., Ltd., Suwon-si (KR)

(72) Inventor: Sunwoong JOO, Suwon-si (KR)

(21) Appl. No.: 19/638,222

(22) Filed: Apr. 3, 2026

Related U.S. Application Data
(63) Continuation of application No. PCT/KR2025/016255, filed on Oct. 15, 2025.

(30) Foreign Application Priority Data
Oct. 15, 2024 (KR) 10-2024-0140550

(51) Int. Cl. G06F 3/01; G06F 3/0346; G06V 40/20; G06F 3/038

(52) U.S. Cl. CPC G06F 3/017; G06F 3/0346; G06V 40/28; G06F 3/038

(57) ABSTRACT

An electronic device includes a camera, a communication interface, a memory, and a processor, wherein the processor is configured to execute a program or at least one instruction and to cause the electronic device to: obtain a user image by capturing an image of at least one user, obtain at least one piece of gesture information corresponding to each of the at least one user by estimating a gesture from the user image, obtain inertial information from an external electronic device, obtain mapping gesture information corresponding to the inertial information, from among the at least one piece of gesture information, based on the at least one piece of gesture information and the inertial information, and obtain a final gesture for controlling the electronic device of a user corresponding to the mapping gesture information among the at least one user, based on the mapping gesture information and the inertial information.

### CROSS-REFERENCE TO RELATED APPLICATIONS

This application is a continuation of International Application No. PCT/KR2025/016255 designating the United States, filed on October 15, 2025, in the Korean Intellectual Property Receiving Office and claiming priority to Korean Patent Application No. 10-2024-0140550, filed on October 15, 2024, in the Korean Intellectual Property Office, the disclosures of each of which are incorporated by reference herein in their entireties.

### BACKGROUND

### FIELD

The disclosure relates to an electronic device and an operating method of the electronic device. For example, the disclosure relates to an electronic device capable of estimating a gesture of a user using the electronic device and an operating method of the electronic device.

### DESCRIPTION OF RELATED ART

With the recent technological developments, technologies for obtaining and utilizing gestures of persons from images obtained by capturing users with cameras have been widely used.

Technologies that use inertial measurement sensors to acquire and utilize information about the movement of devices including inertial measurement sensors have been also widely used.

Recently, technologies for obtaining movements of devices or gestures of persons by fusing information obtained from different types of sensors have been widely used.

Technologies for controlling an operation of an electronic device based on the obtained gestures of persons or movements of devices are also used.

### SUMMARY

According to an example embodiment of the disclosure provides an electronic device. The electronic device may include: a camera; a communication interface comprising circuitry; memory storing a program or at least one instruction; at least one processor including processing circuitry, wherein at least one processor, individually or collectively, may be configured execute the program or the at least one instruction stored in the memory and to cause the electronic device to: obtain, through the camera, a user image by capturing an image of at least one user using the electronic device; obtain at least one piece of gesture information corresponding to each of the at least one user by estimating a gesture from the user image; obtain inertial information from an external electronic device through the communication interface; obtain mapping gesture information corresponding to the inertial information from among the at least one piece of gesture information, based on the at least one piece of gesture information and the inertial information; and obtain a final gesture for controlling the electronic device of a user corresponding to the mapping gesture information among the at least one user, based on the mapping gesture information and the inertial information.

According to an example embodiment of the disclosure, a method of operating an electronic device may be provided. The method may include: obtaining a user image by capturing, through a camera, an image of at least one user using the electronic device; obtaining at least one piece of gesture information corresponding to each of the at least one user by estimating a gesture from the user image; obtaining inertial information from an external electronic device through a communication interface; obtaining mapping gesture information corresponding to the inertial information among the at least one piece of gesture information, based on the at least one piece of gesture information and the inertial information; and obtaining a final gesture for controlling the electronic device of a user corresponding to the mapping gesture information among the at least one user, based on the mapping gesture information and the inertial information.

In an example embodiment of the disclosure, provided is a non-transitory computer-readable recording medium having recorded thereon a program which, when executed by a computer, causes an electronic device to perform at least one operating method.

The disclosure is not limited to the aspects mentioned above, and other technical aspects not mentioned will be clearly understood by one of ordinary skill in the art to which the disclosure belongs from the description below.

### BRIEF DESCRIPTION OF THE DRAWINGS

The disclosure may be understood by combinations of the following detailed descriptions and the accompanying drawings, and reference numerals refer to structural elements. Further, the above and other aspects, features and advantages of certain embodiments of the present disclosure will be more apparent from the following detailed description, taken in conjunction with the accompanying drawings, in which:

FIG. 1 is a diagram illustrating an example operation of an electronic device according to various embodiments;

FIG. 2 is a block diagram illustrating an example configuration of an electronic device according to various embodiments;

FIG. 3 is a flowchart illustrating an example operation of an electronic device according to various embodiments;

FIG. 4 is a diagram illustrating example gesture information estimated from user images according to various embodiments;

FIG. 5 is a diagram illustrating example inertial information obtained from an external electronic device according to various embodiments;

FIG. 6 is a flowchart illustrating an example operation of obtaining mapping sub-gesture information corresponding to a specific body region in which an external electronic device in which inertial information is generated is located, from among a plurality of sub-gesture information, according to various embodiments;

FIG. 7 is a flowchart illustrating an example operation of comparing inertial information with sub-gesture information corresponding to a preset reference body region, from among gesture information, according to various embodiments;

FIG. 8 is a diagram illustrating an example operation of comparing inertial information with sub-gesture information corresponding to a preset reference body region, from among gesture information, according to various embodiments;

FIG. 9 is a flowchart illustrating an example operation of obtaining mapping gesture information based on at least one piece of gesture information and inertial information using an extended Kalman filter according to various embodiments;

FIG. 10 is a diagram illustrating an example operation of obtaining mapping gesture information based on at least one piece of sub-gesture information corresponding to a preset reference body region, from among a plurality of sub-gesture information and inertial information, according to various embodiments;

FIG. 11 is a flowchart illustrating an example operation of obtaining gesture information corresponding to a filtering Kalman gain having the largest value among at least one filtering Kalman gain greater than a preset reference value, as mapping gesture information, according to various embodiments;

FIG. 12 is a flowchart illustrating an example operation of an electronic device to transmit a request signal for requesting inertial information when a period in which the inertial information is obtained is longer than a preset threshold period according to various embodiments;

FIG. 13 is a diagram illustrating an example operation of an electronic device to obtain inertial information transmitted in a broadcast manner and an operation of the electronic device to request the inertial information according to various embodiments;

FIG. 14 is a flowchart illustrating an example operation of an electronic device to transmit a request signal for requesting inertial information when obtained gesture information includes a preset start gesture, according to various embodiments;

FIG. 15 is a diagram illustrating a an example preset start gesture for determining whether to perform an operation of an electronic device according to various embodiments;

FIG. 16 is a flowchart illustrating an example operation of an external electronic device to transmit inertial information when a preset start gesture is included in a gesture obtained based on the inertial information according to various embodiments;

FIG. 17 is a flowchart illustrating an example operation of an electronic device to obtain a final gesture based on a correction weight proportional to the confidence of a user image obtained from a pose estimation model, according to various embodiments; and

FIG. 18 is a diagram illustrating example configurations and operations between an electronic device and an external electronic device according to various embodiments.

### DETAILED DESCRIPTION

The terms used in the disclosure will be briefly described, and various example embodiments of the disclosure will be described in greater detail.

Throughout the disclosure, the expression "or" is inclusive rather than exclusive, unless specifically mentioned otherwise. Hence, unless the context clearly indicates otherwise, "A or B" may refer to "A", "B" or both.

Throughout the disclosure, the expression "at least one of a, b or c" indicates only a, only b, only c, both a and b, both a and c, both b and c, all of a, b, and c, or variations thereof.

In describing the disclosure, descriptions of technical content well known in the technical field to which the disclosure belongs and not directly related to the disclosure may be omitted. This is to convey the gist of the disclosure more clearly without blurring the same by omitting unnecessary explanations.

The terms used herein are those general terms currently widely used in the art in consideration of functions in the disclosure, but the terms may vary according to the intentions of one of ordinary skill in the art, precedents, or new technology in the art. In addition, in some cases, there may be terms that are optionally selected, and the meanings thereof will be described in detail in the corresponding portions of the disclosure. Thus, the terms used herein should be understood not as simple names but based on the meanings of the terms and the overall description of the disclosure.

In the accompanying drawings of the disclosure, some elements are exaggerated, omitted, or schematically illustrated. In addition, the size of each element does not fully reflect the actual size. The same reference numerals are given to the same or corresponding elements in each of the drawings.

An expression used in the singular may encompass the expression of the plural, unless it has a clearly different meaning in the context. All terms including technical and scientific terms used herein have the same meaning as commonly understood by one of ordinary skill in the art to which the disclosure belongs.

Throughout the disclosure, when a part is referred to as "including" a structural element, the part may further include other structural elements rather than excluding other structural elements unless otherwise specified. In addition, as used herein, the terms such as "unit" and "module" may refer to units that perform at least one function or operation, and the unit may be implemented as hardware or software or a combination of hardware and software.

The expression "configured (or set) to" used herein may be used interchangeably with, for example, "suitable for", "having the capacity to", "designed to", "adapted to", "made to", or "capable of" depending on the circumstances. The expression "configured (or set) to" does not essentially refer, for example, to "specially designed in hardware to". Rather, in some circumstances, the expression "system configured to" may refer, for example, to the system performing an operation together with another device or parts. For example, the phrase "a processor configured (or set) to perform A, B, and C" may refer, for example, to a dedicated processor (such as an embedded processor) for performing a corresponding operation, or a generic-purpose processor (such as a central processing unit (CPU) or an application processor (AP)) that may perform a corresponding operation by executing one or more software programs stored in memory.

When it is described herein that one element is “connected” or “coupled” to the other element, it is understood that the one element may be directly connected to or may be directly coupled to the other element but unless explicitly described to the contrary, may be “connected” or “coupled” to the other element through another element therebetween.

In various example embodiments of the disclosure, blocks of each flowchart and combinations of flowcharts may be performed by one or more computer programs including computer-executable instructions. One or more computer programs may be mounted on a processor of a general-purpose computer, special-purpose computer, or other programmable data processing equipment, and instructions executed through the processor of the computer or other programmable data processing equipment may generate means for performing the functions described in the flowchart block(s). The one or more computer programs may be stored all in a single memory or may be distributed in many different memories.

Each block in the flowchart may represent a module, a segment, or a part of a code including one or more executable instructions for executing a specified logical function(s). In various embodiments of the disclosure, it is possible that the functions mentioned in the blocks are performed out of order. For example, two blocks shown one after another may be performed substantially simultaneously or may be performed in reverse order according to functions.

All functions or operations described herein may be processed by one processor or a combination of a plurality of processors.

Functions related to artificial intelligence (AI) according to the disclosure are operated through a processor and memory. The one or more processors control input data to be processed according to an AI model or predefined operation rules stored in memory. When the one or more processors include dedicated AI processors, the dedicated AI processors may be designed with a hardware structure specialized in processing a specific AI model.

The AI model or the predefined operation rules are characterized by being made by training. Here, "being made by training" refers to a basic AI model is trained by a learning algorithm using a large number of pieces of training data, and thus, the AI model or the predefined operation rules set to perform intended features (or purposes) are made. Such training may be performed by a device itself in which AI according to the disclosure is performed, or may be performed by a separate server and/or system. The learning algorithm may include, but is not limited to, for example, supervised learning, unsupervised learning, semi-supervised learning, or reinforcement learning.

The neural network model may include a plurality of neural network layers. Each of the plurality of neural network layers has a plurality of weight values and performs a neural network operation through an operation between an operation result of a previous layer and the plurality of weight values. The plurality of weight values of each of the plurality of neural network layers may be optimized by a training result of the AI model. For example, the plurality of weight values may be updated such that a loss value or a cost value obtained by the AI model during a training process is minimized/reduced. An artificial neural network model may include a deep neural network (DNN), for example, a convolutional neural network (CNN), a recurrent neural network (RNN), a restricted Boltzmann machine (RBM), a deep belied network (DBN), a bidirectional recurrent deep neural network (BRDNN), or a deep Q-network, but the disclosure is not limited thereto.

Hereinafter, various example embodiments of the disclosure will be described in greater detail with reference to the accompanying drawings . The disclosure may, however, be embodied in many different forms and should not be understood as being limited to the various embodiments set forth herein. In order to clearly explain example embodiments of the disclosure in the drawings, parts that are not related to the description may be omitted, and similar parts are given similar reference numerals throughout the disclosure.

Various example embodiments of the disclosure now will be described more fully hereinafter with reference to the accompanying drawings.

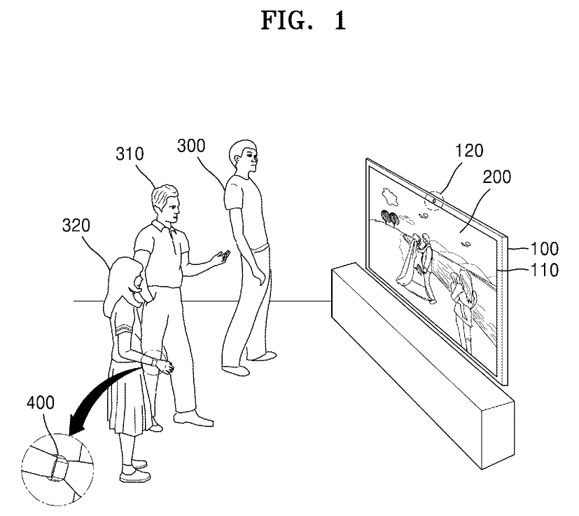

FIG. 1 is a diagram illustrating an example operation of an electronic device according to various embodiments.

Referring to FIG. 1, in an embodiment of the disclosure, an electronic device 100 may display an image 200 and provide the image 200 to a plurality of users 300, 310, and 320. The electronic device 100 may include a display 110 displaying the image 200. The electronic device 100 may display the image 200 through the display 110 to provide the image 200 to the users 300, 310, and 320.

In an embodiment of the disclosure, FIG. 1 shows that the electronic device 100 is a television. However, the disclosure is not limited thereto. The electronic device 100 may be implemented as an electronic device such as, for example, and without limitation, a mobile device, a smart phone, a laptop computer, a desktop, a tablet PC, a digital signage, a projector, a wearable device, or the like.

In an embodiment of the disclosure, FIG. 1 shows that the three users 300, 310, and 320 use the electronic device 100. However, the disclosure is not limited thereto, and the number of users using the electronic device 100 may be at least one, less than three, or more than three. Hereinafter, for convenience of descriptions, it will be described that the number of users using the electronic device 100 is three.

In an embodiment of the disclosure, the electronic device 100 may estimate gestures of the plurality of users 300, 310, and 320 using the electronic device 100.

For example, the electronic device 100 may include a camera 120. The electronic device 100 may obtain user images by capturing images of the users 300, 310, and 320 through the camera 120. The electronic device 100 may estimate gestures of the plurality of users 300, 310, and 320 from the user images. The gestures of the plurality of users 300, 310, and 320 may be gestures for controlling the operation of the electronic device 100. The electronic device 100 may estimate the gestures of the plurality of users 300, 310, and 320 from the user images through a pose estimation model.

In this regard, a feature point may be detected from the user images through the pose estimation model. The term "feature point" may refer to a point within an image that is distinguished from or easily identified from the surrounding background. The feature point may include a skeleton, a hand, a face, etc. In an embodiment of the disclosure, a "gesture" may refer to a shape corresponding to a plurality of feature points and a form generated by connecting the plurality of feature points with lines.

In an embodiment of the disclosure, the operation of the electronic device 100 may be controlled based on the estimated gestures of the plurality of users 300, 310, and 320. The plurality of users 300, 310, and 320 using the electronic device 100 may include the first user 300, the second user 310 and the third user 320.

In an embodiment of the disclosure, the operation of the electronic device 100, for example, a change in the type of an image displayed on the display 110, a change in the sound or size of the image, a type of an application executed by the electronic device 100, or a control within the application, may be controlled by the estimated gesture of each of the first user 300, the second user 310, and the third user 320. In this regard, the content of the operation controlled in response to the estimated type of gesture may be set in advance.

However, when a part of the body of each of the plurality of users 300, 310, and 320 captured by the camera 120 is covered by an obstacle or another user, or when the image quality or resolution of the user images obtained through the camera 120 is low, the accuracy of the gestures of the plurality of users 300, 310, and 320 estimated from the user images may be low. Accordingly, the operation of the electronic device 100 may be controlled differently from the intentions of the plurality of users 300, 310, and 320.

In an embodiment of the disclosure, at least one user of the plurality of users 300, 310, and 320 using the electronic device 100 may use another electronic device 400 different from the electronic device 100. In this regard, the other electronic device 400 may be referred to as an external electronic device 400. In an embodiment of the disclosure, the third user 320 may use the electronic device 100 while wearing the external electronic device 400.

In an embodiment of the disclosure, the external electronic device 400 may be a wearable device that may be worn by a user. The external electronic device 400 may be an electronic device having various forms such as, for example, and without limitation, a watch, an earphone, a bracelet, a ring, a belt, etc. The external electronic device 400 may include a smart watch, a smart ring, a wireless earphone, a head mounted display device, etc. In an embodiment of the disclosure, the third user 320 may use the electronic device 100 while wearing the external electronic device 400 in the form of a smart watch on the left wrist.

However, the disclosure is not limited thereto, and the external electronic device 400 may be an electronic device that may be moved together when the user moves the user’s body while using the electronic device 100, such as a mobile device or a smart phone. Hereinafter, for convenience of descriptions, it will be described that the external electronic device 400 is a wearable device.

In an embodiment of the disclosure, the external electronic device 400 may include an inertial measurement unit (IMU). The external electronic device 400 may obtain inertial information by measuring a change in inertial according to a movement of a user wearing the external electronic device 400. The external electronic device 400 may obtain inertial information by measuring a change in inertial according to a movement of a left hand of the third user 320, for example, a movement of a finger or a palm included in the left hand, a movement of a left wrist, etc.

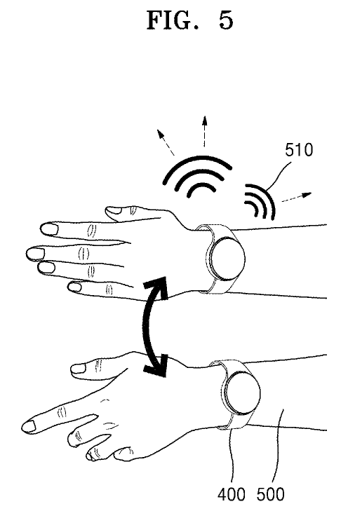

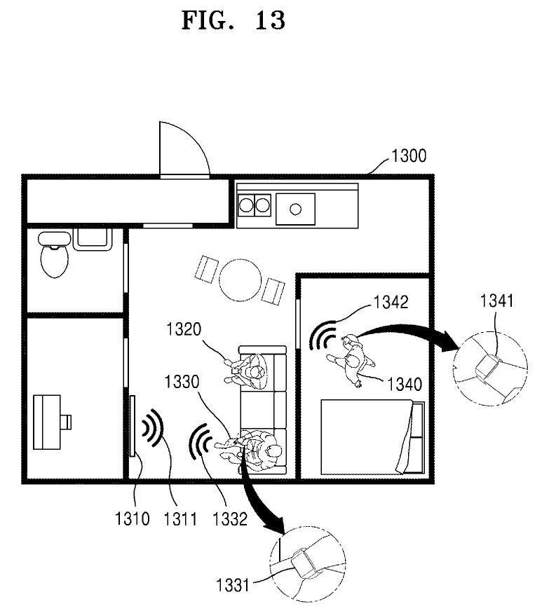

The external electronic device 400 may provide the inertial information to the electronic device 100 through a communication interface. In an embodiment of the disclosure, the external electronic device 400 may transmit the inertial information to the surroundings in a broadcast manner, and the electronic device 100 may obtain the inertial information through the communication interface included in the electronic device 100. An example method of transmitting inertial information will be described in greater detail below with reference to FIGS. 5 and 13.

In an embodiment of the disclosure, the inertial information is provided in a broadcast manner, and the inertial information obtained by the electronic device 100 may not include information about which of the plurality of users 300, 310, and 320 wears the external electronic device 400. The inertial information may not include information about which part of the body the change in inertial according to the movement of the body is obtained by the external electronic device 400.

In an embodiment of the disclosure, the electronic device 100 may obtain a plurality of gesture information from the gestures of the plurality of users 300, 310, and 320 estimated from the user images.

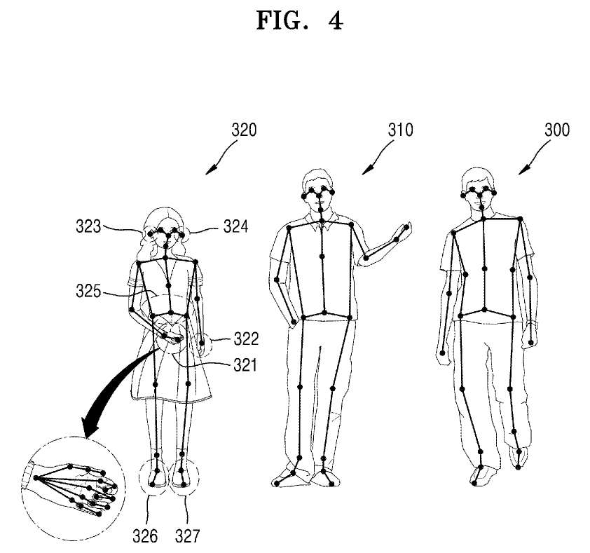

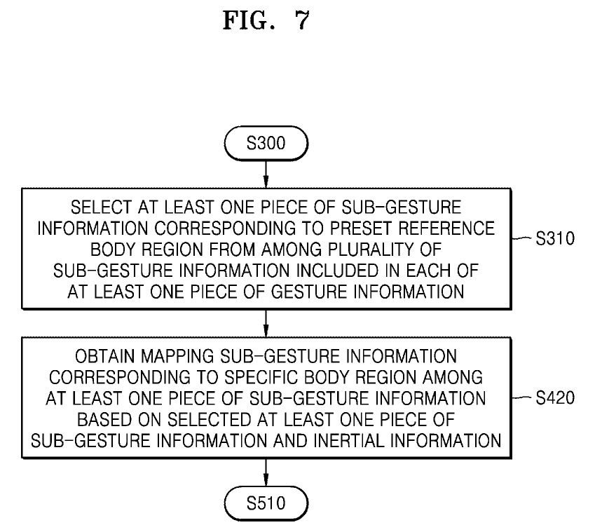

In an embodiment of the disclosure, the "gesture information" may include information according to relative position changes of a plurality of feature points included in a gesture. In an embodiment of the disclosure, as at least one user uses the electronic device 100, and thus the electronic device 100 may obtain at least one piece of gesture information. Gesture information will be described in greater detail below with reference to FIGS. 4 and 7.

The electronic device 100 of the disclosure may obtain mapping gesture information corresponding to inertial information from among a plurality of gesture information based on the plurality of gesture information respectively corresponding to a plurality of users and the inertial information. Accordingly, the electronic device 100 may check which of the plurality of users 300, 310, and 320 is wearing the external electronic device 400 that provides the inertial information. In an embodiment of the disclosure, the electronic device 100 may compare each of the gesture information of the first user 300, the gesture information of the second user 310, and the gesture information of the third user 320 with the inertial information to confirm that the gesture information of the third user 320 corresponds to the obtained inertial information.

In an embodiment of the disclosure, the electronic device 100 may obtain mapping gesture information corresponding to the inertial information from among the plurality of gesture information using an extended Kalman filter (EKF). The electronic device 100 may obtain gesture information corresponding to a Kalman gain having the largest value among a plurality of Kalman gains of inertial information respectively with respect to the plurality of gesture information as the mapping gesture information.

The electronic device 100 may check which part of the user's body the change in inertial according to the movement of the body is included in the inertial information. In an embodiment of the disclosure, each of the plurality of gesture information may include a plurality of sub-gesture information respectively corresponding to a plurality of body regions of person. The electronic device 100 may obtain mapping sub-gesture information corresponding to a region in which the external electronic device 400 is located among the plurality of sub-gesture information included in each of the plurality of gesture information based on the plurality of sub-gesture information and the inertial information. In an embodiment of the disclosure, the electronic device 100 may compare the inertial information with the plurality of sub-gesture information included in each of the gesture information of the first user 300, the gesture information of the second user 310, and the gesture information of the third user 320 to confirm that sub-gesture information corresponding to a left hand region of the third user 320 corresponds to the inertial information.

In this regard, the electronic device 100 may select at least one piece of sub-gesture information corresponding to a predetermined reference body region as a region in which the external electronic device 400 may be located from among the plurality of sub-gesture information, and obtain mapping sub-gesture information corresponding to the inertial information among the at least one piece of selected sub-gesture information using the extended Kalman filter.

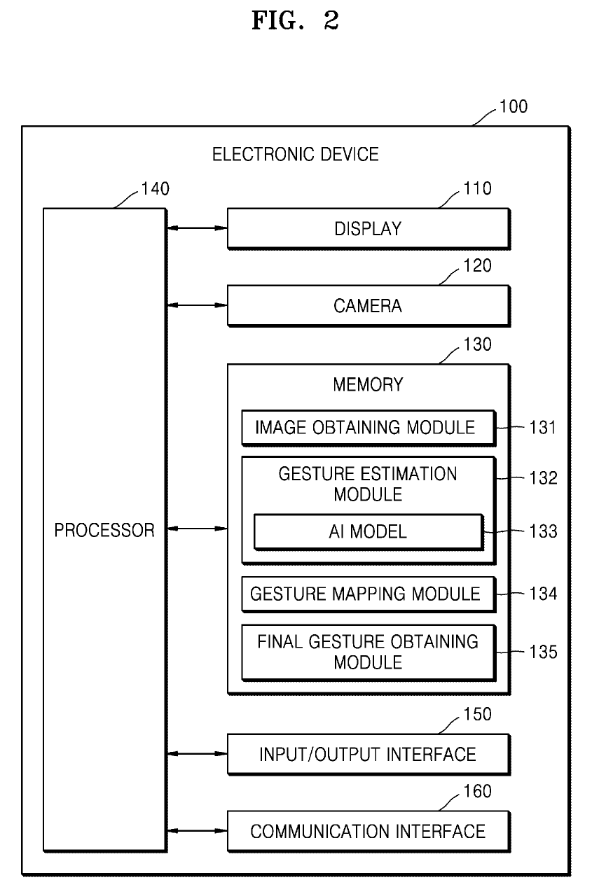

Accordingly, the electronic device 100 may reduce the amount of operation and power consumption required to obtain the mapping sub-gesture information corresponding to the inertial information. An operation of obtaining mapping gesture information corresponding to inertial information among a plurality of gesture information and an operation of obtaining mapping sub-gesture information will be described in greater detail below with reference to FIGS. 2, 9, and 10.

In an embodiment of the disclosure, the electronic device 100 may obtain a user's gesture corresponding to the mapping gesture information among the plurality of users 300, 310, and 320 based on the mapping gesture information and the inertial information. In this case, the gesture estimated based on the mapping gesture information and the inertial information may be referred to as a "final gesture". The electronic device 100 may obtain a user’s final gesture by the body region corresponding to the mapping gesture information in which the external electronic device 400 is located based on the mapping sub-gesture information and the inertial information. In an embodiment of the disclosure, the electronic device 100 may obtain a final gesture of the third user 320 using the mapping gesture information and the inertial information. The electronic device 100 may obtain a final gesture by a left hand of the third user 320 using the mapping sub-gesture information and the inertial information.

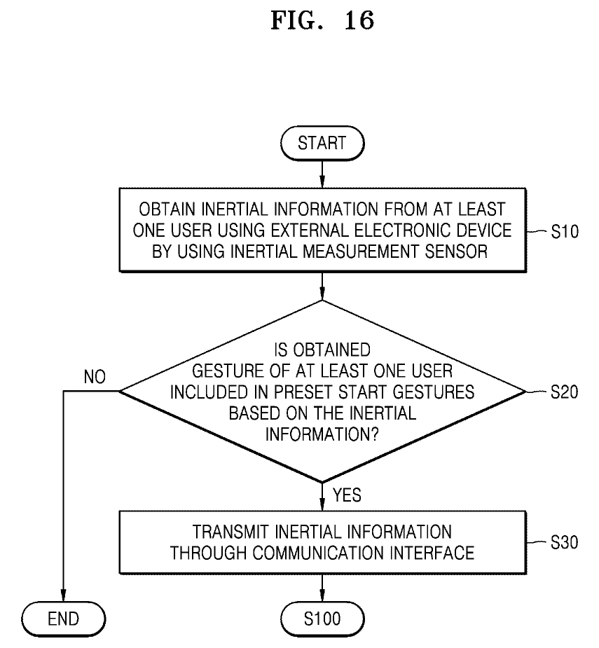

In an embodiment of the disclosure, the electronic device 100 may obtain a final gesture based on the mapping gesture information and the inertial information using the extended Kalman filter. In this regard, the mapping gesture information may include mapping sub-gesture information, and the electronic device 100 may obtain a final gesture based on the mapping sub-gesture information and the inertial information using the extended Kalman filter. An operation of obtaining a final gesture will be described in greater detail below with reference to FIGS. 2 and 16.

In an embodiment of the disclosure, the electronic device 100 obtains a final gesture using not only gesture information obtained from a user image but also inertial information obtained from the external electronic device 400, and thus the accuracy of the user’s final gesture recognized by the electronic device 100 may increase. For example, even though a part of the user's body included in a user image is covered by an obstacle or another user, or the resolution of the user image is low, inertial information may be considered together, and thus the accuracy of the operation of recognizing the user's final gesture may increase. In addition, the user image may be considered together in recognizing the user's final gesture, thereby preventing and/or reducing a drift error in which errors are accumulated over time that may occur when recognizing a user's gesture by considering only inertial information.

In an embodiment of the disclosure, the electronic device 100 may use mapping gesture information corresponding to inertial information provided in a broadcast manner among at least one piece of user gesture information to obtain a final gesture, thereby utilizing the inertial information provided from the external electronic device 400 that has not been previously paired with the electronic device 100. Accordingly, the electronic device 100 according to the disclosure may obtain a user’s final gesture by utilizing inertial information provided from the external electronic device 400 newly worn by a user using the electronic device 100 or inertial information provided from the external electronic device 400 worn by a user who first came to use the electronic device 100.

The electronic device 100 of the disclosure may control the operation of the electronic device 100 based on the final gesture.

However, the disclosure is not limited thereto, and the electronic device 100 may be implemented as an electronic device in various forms such as a desktop, a set-top box, or a server device that does not include a display. In this case, the electronic device 100 may provide the obtained final gesture to an external electronic device through an input/output interface. The electronic device 100 may provide the obtained final gesture to an external server through a communication interface.

The electronic device 100 may estimate the gestures of the first user 300 and the second user 310 from the user images.

FIG. 2 is a block diagram illustrating an example configuration of an electronic device according to various embodiments.

Referring to FIGS. 1 and 2, in an embodiment of the disclosure, the electronic device 100 may include the display 110, the camera 120, memory 130, at least one processor (e.g., including processing circuitry) 140, an input/output interface (e.g., including input/output circuitry) 150, and a communication interface (e.g., including communication circuitry) 160.

However, not all of the components shown in FIG. 2 are essential components. The electronic device 100 may be implemented with more or fewer components than in FIG. 2. In an embodiment of the disclosure, the electronic device 100 may not include the display 110.

The display 110, the camera 120, the memory 130, the at least one processor 140, the input/output interface 150, and the communication interface 170 included in the electronic device 100 may be electrically connected to one another.

In an embodiment of the disclosure, the display 110 may include any one of a liquid crystal display, a plasma display, an organic light emitting diode display, and an inorganic light emitting diode display. However, the disclosure is not limited thereto, and the display 110 may include another type of display capable of displaying the image 200.

In an embodiment of the disclosure, the at least one processor 140 may include various processing circuitry and control the display 110 to display the image 200, and the electronic device 100 may provide the image to the plurality of users 300, 310, and 320.

In an embodiment of the disclosure, the camera 120 may obtain user images by capturing images of the plurality of users 300, 310, and 320 using the electronic device 100. In an embodiment of the disclosure, the camera 120 may include an RGB camera capable of obtaining an image including RGB information. However, the disclosure is not limited thereto, and the camera 120 may include a stereo camera including two RGB cameras, an RGB-depth camera obtaining an image including RGB information and depth information, or a black and white camera obtaining a black and white image, and is not limited to any one of these.

The at least one processor 140 may control the camera 120 to capture an image of at least one user 300 using the electronic device 100, so that the electronic device 100 may obtain a user image.

In an embodiment of the disclosure, instructions, a data structure and program codes that are readable by the at least one processor 140 may be stored in the memory 130. In an embodiment of the disclosure, there may be one or more memories 130. Operations performed by the electronic device 100 may be implemented to cause the at least one processor 140 to execute instructions or codes of a program stored in the memory 130.

In an embodiment of the disclosure, the memory 130 may include at least one of a flash memory type, a hard disk type, a multimedia card micro type, a card type memory (e.g., secure digital (SD) or extreme digital (XD) memory), a static random access memory (RAM), a static RAM (SRAM), a read-only memory (ROM), an electrically erasable read-only memory (EPROM), a programmable read-only memory (PROM), a mask ROM, a flash ROM, a hard disc drive (HDD) or a solid state drive (SSD).

In an embodiment of the disclosure, the memory 130 may not be separately present but may be configured to be included in the at least one processor 140.

In an embodiment of the disclosure, instructions or program codes for performing functions or operations of the electronic device 100 may be stored in the memory 130. The instructions, algorithms, data structures, program codes and application programs stored in the memory 130 may be implemented in, for example, a programming or scripting language such as C, C++, Java, python, assembler, etc.

In an embodiment of the disclosure, various types of modules that may be used to perform operations of the electronic device 100 may be stored in the memory 130.

In an embodiment of the disclosure, the memory 130 may store an image obtaining module 131, a gesture estimation module 132, a gesture mapping module 134, and a final gesture obtaining module 135, each of which may include various circuitry and/or executable program instructions. However, not all of the modules shown in FIG. 2 are essential. The memory 130 may store more or fewer modules than those stored in FIG. 2.

In an embodiment of the disclosure, the memory 130 may further store a module including instructions or program codes related to an operation or function of selecting at least one piece of sub-gesture information corresponding to a preset reference body region among a plurality of sub-gesture information or a module including instructions or program codes related to an operation or function of determining whether a period in which inertial information is obtained is longer than a preset threshold period.

In an embodiment of the disclosure, the 'module' included in the memory 130 may refer to a unit for processing a function or operation performed by the at least one processor 140. The 'module' included in the memory 130 may be implemented as software such as instructions, algorithm, a data structure, or program codes.

In an embodiment of the disclosure, the image obtaining module 131 may include instructions or program codes related to an operation or function of obtaining a user image by capturing an image of at least one user using the electronic device 100 through the camera 120.

In an embodiment of the disclosure, the at least one processor 140 may execute the instructions or program code of the image obtaining module 131 to cause the electronic device 100 to obtain a user image by capturing an image of at least one user using the electronic device 100 through the camera 120.

In an embodiment of the disclosure, the gesture estimation module 132 may include instructions or program codes related to an operation or function of estimating a gesture of each of at least one user from the obtained user image.

In an embodiment of the disclosure, the gesture estimation module 132 may include instructions or program codes related to an operation or function of detecting a plurality of feature points and detecting a person pose by connecting the detected plurality of feature points.

In an embodiment of the disclosure, the gesture estimation module 132 may include a pose estimation model estimating a person’s pose. However, the disclosure is not limited thereto, and the gesture estimation module 132 may include an AI model 133 pre-trained to infer at least one user’s pose included in the user image. In an embodiment of the disclosure, the gesture estimation module 132 may include a model such as OpenPose, AlphaPose, and a cascaded pyramid network (CPN). The gesture estimation module 132 may estimate a person’s pose from an image using a deep learning-based model such as a convolutional neural network (CNN), a transformer, or a vision transformer, and the AI model 133 in the disclosure is not limited to the above-described examples.

In an embodiment of the disclosure, the at least one processor 140 may execute instructions or program codes of the gesture estimation module 132 to cause the electronic device 100 to estimate the gesture of at least one user included in the obtained user image.

In an embodiment of the disclosure, the gesture estimation module 132 may include instructions or program codes related to an operation or function of obtaining gesture information including relative position changes in a plurality of feature points included in the estimated gesture of at least one user.

In an embodiment of the disclosure, relative positions of the plurality of feature points may change over time according to linear movement of the plurality of feature points included in the gesture in a direction of at least one of x-axis, y-axis, or z-axis. In addition, relative positions of the plurality of feature points may change over time according to rotational motion of the plurality of feature points included in the gesture with respect to at least one of x-axis, y-axis, or z-axis. In an embodiment of the disclosure, the gesture information may include information about relative position changes in the plurality of feature points included in the at least one gesture.

In an embodiment of the disclosure, the at least one processor 140 may execute instructions or program codes of the gesture estimation module 132 to cause the electronic device 100 to obtain at least one piece of gesture information corresponding to each of the at least one user based on the gesture of the at least one user estimated from the user image.

In an embodiment of the disclosure, the gesture mapping module 134 may include instructions or program codes related to an operation or function of obtaining mapping gesture information corresponding to inertial information obtained through the communication interface 160 among the at least one piece of gesture information based on the inertial information and the at least one piece of gesture information.

In an embodiment of the disclosure, the inertial information obtained through the communication interface 160 may include a 6 degree of freedom (6DoF) value including information about acceleration values of three-dimensional axes (x-axis, y-axis, and z-axis) and angular velocity values of rotations (roll, yaw, and pitch) with respect to the three-dimensional axes according to a movement of a user wearing the external electronic device 400.

However, the disclosure is not limited thereto, and the inertial information obtained through the communication interface 160 may include a 3 degree of freedom (eDoF) value including the information about the acceleration values of three-dimensional axes (x-axis, y-axis, and z-axis) according to the movement of the user wearing the external electronic device 400.

In an embodiment of the disclosure, the inertial information according to a gesture of the user wearing the external electronic device 400 and gesture information obtained from a user image obtained by capturing the gesture of the user wearing the external electronic device 400 with the camera 120 are obtained from the same gesture, and thus a difference therebetween may not be significant.

On the other hand, the inertial information according to a gesture of the user wearing the external electronic device 400 and gesture information obtained from a user image obtained by capturing a gesture of another person with the camera 120, other than the user wearing the external electronic device 400, may be obtained from different gestures, and thus a difference therebetween may be significant.

In an embodiment of the disclosure, the gesture mapping module 134 may include instructions or program codes related to an operation or function of obtaining mapping gesture information corresponding to the inertial information obtained from the communication interface 160 among the at least one piece of gesture information obtained from the gesture estimation module 132 based on the at least one piece of gesture information and the inertial information. The gesture mapping module 134 may include instructions or program codes related to an operation or function of obtaining gesture information having the smallest difference from the inertial information among the at least one piece of gesture information as the mapping gesture information.

In an embodiment of the disclosure, the gesture mapping module 134 may include instructions or program codes related to an operation or function of obtaining at least one Kalman gain of the inertial information with respect to each of the at least one piece of gesture information by using an extended Kalman filter and obtaining gesture information corresponding to a Kalman gain having the largest value among the at least one Kalman gain as mapping gesture information.

In an embodiment of the disclosure, the at least one processor 140 may execute instructions or program codes of the gesture mapping module 134 to cause the electronic device 100 to obtain mapping gesture information corresponding to inertial information among at least one piece of gesture information based on the at least one piece of gesture information and the inertial information.

In an embodiment of the disclosure, the at least one piece of gesture information may include a plurality of sub-gesture information corresponding to each of a plurality of body regions of each user. The gesture mapping module 134 may include instructions or program codes related to an operation or function of obtaining at least one Kalman gain of inertial information with respect to each of the plurality of sub-gesture information included in the at least one piece of gesture information using the extended Kalman filter and obtaining sub-gesture information corresponding to a Kalman gain having the largest value among the at least one Kalman gain as mapping sub-gesture information.

In an embodiment of the disclosure, the at least one processor 140 may execute instructions or program code of the gesture mapping module 134 to cause the electronic device 100 to obtain mapping sub-gesture information corresponding to inertial information from among a plurality of sub-gesture information based on the plurality of sub-gesture information and the inertial information.

In an embodiment of the disclosure, the final gesture obtaining module 135 may include instructions or program codes related to an operation or function of obtaining a final gesture of a user corresponding to the mapping gesture information among the at least one user based on the mapping gesture information and the inertial information.

The final gesture obtaining module 135 may include a sensor fusion model, and through this, include instructions or program codes related to an operation or function of obtaining the final gesture of the user from the mapping gesture information and the inertial information. In an embodiment of the disclosure, the final gesture obtaining module 135 may include an extended Kalman filter algorithm.

However, the disclosure is not limited thereto, and the final gesture obtaining module 135 may include the AI model 133 pre-trained to infer features by combining data obtained from different types of sensors. In an embodiment of the disclosure, the final gesture obtaining module 135 may include a deep learning-based model such as a CNN, an RNN, a long short-term memory (LSTM), etc., and the AI model in the disclosure is not limited to the above-described examples.

In an embodiment of the disclosure, the at least one processor 140 may execute instructions or program codes of the final gesture obtaining module 135 to cause the electronic device 100 to obtain the final gesture of the user corresponding to the mapping gesture information among the at least one user based on the plurality of sub-gesture information and the inertial information.

In an embodiment of the disclosure, the at least one processor 140, which is a configuration to control a series of processes so that the electronic device 100 operates according to the various embodiments of the disclosure described below, may include one or a plurality of processors.

In an embodiment of the disclosure, the at least one processor 140 may be configured with at least one of a central processing unit (CPU), a microprocessor, a graphic processing unit (GPU), an application processor (AP), an application specific integrated circuit (ASIC), a digital signal processor (DSP), a digital signal processing device (DSPD), a programmable logic device (PLD), a field programmable gate array (FPGA), a communication processor (CP), and/or an AI-only processor designed in a hardware structure specialized for learning and processing an AI model, but is not limited thereto. Thus, the processor 140 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

In an embodiment of the disclosure, when one or more processors included in the at least one processor 140 are AI-only processors, the AI-only processors may be designed in a hardware structure specialized for processing a specific AI model.

In an embodiment of the disclosure, the at least one processor 140 may include circuitry such as a system on chip (SoC) or an integrated circuit (IC).

In an embodiment of the disclosure, the at least one processor 140 may execute various types of modules stored in the memory 130. The at least one processor 140 may individually or collectively execute at least one instruction included in various types of modules stored in the memory 130. The at least one processor 140 may process data according to a predefined operation rule or an AI model by executing a program or at least one instruction stored in the memory 130,

In an embodiment of the disclosure, the at least one processor 140 may include a plurality of processors. In an embodiment of the disclosure, at least one of the plurality of modules in the memory 130 may be executed by any one of the plurality of processors. Among the plurality of modules stored in the memory 130, the remaining modules may be executed by another processor among the plurality of processors.

In an embodiment of the disclosure, the input/output interface 150 may include various input/output circuitry and receive a user image obtained by capturing an image of a user using the electronic device 100 from an electronic device outside by the control of the at least one processor 140. The electronic device 100 may obtain the user image from the electronic device outside through the input/output interface 150 rather than the user image obtained by the camera 120.

The input/output interface 150 may provide the final gesture obtained according to the disclosure to the electronic device outside by the control of the at least one processor 140. In this regard, the electronic device outside may control the operation thereof based on the final gesture obtained from the electronic device 100.

In an embodiment of the disclosure, the input/output interface 150 may perform an input/output operation with the electronic device outside using at least one of input/output types including a high-definition multimedia interface (HDMI) port, a digital visual interface (DVI), a component jack, a PC port, or a universal serial bus (USB) port. However, the disclosure is not limited to the above-described input/output types.

In an embodiment of the disclosure, the communication interface 160 may include various communication circuitry and perform data communication with a server outside or the electronic device outside by the control of the at least one processor 140.

For example, the communication interface 160 may perform data communication with the server outside or the electronic device outside using at least one of data communication types including, for example, wired local region network (WLAN), wireless LAN, Wi-Fi, Bluetooth, Zigbee, Wi-Fi Direct (WFD), infrared data association (IrDA), Bluetooth low energy (BLE), near field communication (NFC), wireless broadband Internet (Wibro), world interoperability for microwave access (WiMAX), shared wireless access protocol (SWAP), wireless gigabit alliance (WiGig), and radio frequency (RF) communication.

In an embodiment of the disclosure, the communication interface 160 may provide the final gesture obtained according to the disclosure to the server outside or the electronic device outside by the control of at least one processor 140.

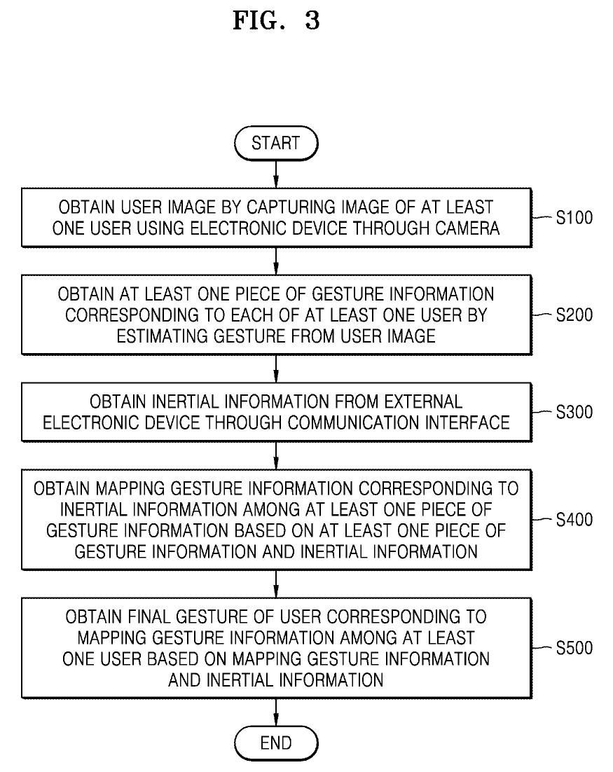

FIG. 3 is a flowchart illustrating an example operation of an electronic device according to various embodiments.

Referring to FIGS. 1, 2, and 3, in an embodiment of the disclosure, a method of operating the electronic device 100 may include operation S100 of obtaining a user image by capturing an image of at least one user using the electronic device 100 through the camera 120.

In operation S100, the at least one processor 140 may execute instructions or program codes of the image obtaining module 131 to cause the electronic device 100 to obtain the user image by capturing an image of the at least one user using the electronic device 100 through the camera 120.

In an embodiment of the disclosure, the method of operating the electronic device 100 may include operation S200 of obtaining at least one piece of gesture information corresponding to each of the at least one user by estimating a gesture of the at least one user from the user image.

In operation S200, the at least one processor 140 may execute instructions or program codes of the gesture estimation module 132 to cause the electronic device 100 to obtain the at least one piece of gesture information corresponding to each of the at least one user by estimating the gesture of the at least one user from the user image.

In an embodiment of the disclosure, the method of operating the electronic device 100 may include operation S300 of obtaining inertial information from the external electronic device 400 through the communication interface 160.

In operation S300, the at least one processor 140 may control the operation of the communication interface 160 to cause the electronic device 100 to obtain the inertial information from the external electronic device 400 through the communication interface 160. In this regard, the inertial information may be transmitted by the external electronic device 400 in a broadcast manner.

In an embodiment of the disclosure, the method of operating the electronic device 100 may include operation S400 of obtaining mapping gesture information corresponding to the inertial information among the at least one piece of gesture information based on the at least one piece of gesture information and the inertial information.

In operation S400, the at least one processor 140 may execute instructions or program code of the gesture mapping module 134 to cause the electronic device 100 to obtain the mapping gesture information corresponding to the inertial information among the at least one piece of gesture information based on the at least one piece of gesture information and the inertial information. The electronic device 100 may calculate at least one Kalman gain of the inertial information with respect to each of the at least one piece of gesture information by using an extended Kalman filter and then obtain gesture information corresponding to a Kalman gain having the largest value among the calculated at least Kalman gain as the mapping gesture information.

In an embodiment of the disclosure, the method of operating the electronic device 100 may include operation S500 of obtaining a final gesture of a user corresponding to the mapping gesture information among the at least one user based on the mapping gesture information and the inertial information.

In operation S500, the at least one processor 140 may execute instructions or program codes of the final gesture obtaining module 135 to cause the electronic device 100 to obtain the final gesture of the user corresponding to the mapping gesture information among the at least one user based on the mapping gesture information and the inertial information. The electronic device 100 may obtain the final gesture of the user corresponding to the mapping gesture information based on the mapping gesture information and the inertial information using the extended Kalman filter.

In this regard, the at least one user and the at least one piece of gesture information do not mean one user and one gesture information. The at least one user may refer, for example, to one user or two or more users, and the at least one piece of gesture information may refer, for example, to one gesture information or two or more gesture information.

FIG. 4 is a diagram illustrating gesture information estimated from user images according to various embodiments.

Referring to FIGS. 1, 2, and FIG. 4, in an embodiment of the disclosure, FIG. 4 shows the user images obtained by capturing images of the three users 300, 310, and 320 using the electronic device 100 and a plurality of feature points included in each of the three users 300, 310, and 320 detected from the user image through the electronic device 100 and lines connecting the plurality of feature points.

In an embodiment of the disclosure, the electronic device 100 may estimate shapes corresponding to the detected plurality of feature points and forms generated by connecting the plurality of feature points with the lines as gestures of the three users 300, 310, and 320.

In an embodiment of the disclosure, the electronic device 100 may obtain gesture information including information about relative position changes over time in the plurality of feature points included in the gestures from the gestures estimated from the user images.

In an embodiment of the disclosure, the user image may include a plurality of body regions of each of the three users 300, 310, and 320. In an embodiment of the disclosure, the plurality of body regions may include a left hand region 321, a right hand region 322, a left ear region 323, a right ear region 324, a waist region 325, a left foot region 326, a right foot region 327, etc. However, the disclosure is not limited thereto, and may include various body regions in addition to the body regions shown in FIG. 4.

FIG. 4 shows that the entire body of each of the three users 300, 310, and 320 is wholly included in the user image, but the disclosure is not limited thereto. According to an angle of view of the camera 120, distances between the camera 120 and the three users 300, 310, and 320, an arrangement between the camera 120 and the three users 300, 310, and 320, the user image may include a partial region of the body of each of the three users 300, 310, and 320.

In an embodiment of the disclosure, the gesture information may include a plurality of sub-gesture information respectively corresponding to the plurality of body regions of each of the three users 300, 310, and 20. In this regard, the "sub-gesture information" may include information about relative position changes in a plurality of feature points located in a corresponding body region.

In an embodiment of the disclosure, the sub-gesture information corresponding to the left hand region 321 may include information about relative position changes in a plurality of feature points detected from a left hand image located in the left hand region 321. In an embodiment of the disclosure, the sub-gesture information corresponding to the right hand region 322 may include information about relative position changes in a plurality of feature points detected from a right hand image located in the right hand region 322.

FIG. 5 is a diagram illustrating inertial information obtained from an external electronic device according to various embodiments.

Referring to FIGS. 1, 2, and 5, in an embodiment of the disclosure, a part 500 left wrist 500 of a user's body wearing the external electronic device 400 among at least one user using the electronic device 100 and the external electronic device 400 are shown in FIG. 5.

In an embodiment of the disclosure, the external electronic device 400 may be a smart watch, and the part 500 of the user's body on which the external electronic device 400 is worn may be a left wrist. However, the disclosure is not limited thereto, and a position of the body on which the external electronic device 400 is worn may vary depending on a type or a shape of the external electronic device 400.

In an embodiment of the disclosure, the external electronic device 400 may include an inertial measurement sensor. In an embodiment of the disclosure, the inertial measurement sensor may include an acceleration sensor and an angular velocity sensor, for example, a gyroscope. The inertial measurement sensor may obtain acceleration values of three-dimensional axes (x-axis, y-axis, and z-axis) according to a movement of the user through the acceleration sensor. The inertial measurement sensor may obtain angular velocity values of rotations (roll, yaw, and pitch) with respect to three-dimensional axes according to a movement of the user through the angular velocity sensor. The external electronic device 400 may obtain inertial information 510 by sensing a movement of the user's body wearing the external electronic device 400, for example, a movement of the left wrist 500 upward, downward, leftward, or rightward, or a rotation of the left wrist 500 in a counterclockwise or clockwise direction.

In an embodiment of the disclosure, when a slight movement or rotation occurs in the left wrist 500 according to a movement of the finger included in the left hand, the external electronic device 400 may obtain the inertial information 510 by sensing the movement of the finger included in the left hand.

The external electronic device 400 may recognize a gesture of the user's left hand wearing the external electronic device 400 through a pre-trained AI model so as to infer what movement or gesture the finger included in the left hand is taking according to the obtained inertial information 510.

In an embodiment of the disclosure, the external electronic device 400 may transmit the inertial information 510 obtained to the surroundings of the external electronic device 400 through a communication interface. In this regard, the inertial information 510 may be transmitted to the surroundings of the external electronic device 400 in the broadcast manner through the communication interface.

In an embodiment of the disclosure, the external electronic device 400 may broadcast the inertial information 510 included in an advertising packet of BLE through the communication interface. In addition, the external electronic device 400 may broadcast the inertial information 510 included in an advertising packet of Wi-Fi Aware through the communication interface. However, the disclosure is not limited thereto, and the external electronic device 400 may use various communication methods capable of providing the inertial information 510 to nearby electronic devices that are not paired in the broadcast manner.

In an embodiment of the disclosure, the external electronic device 400 may periodically broadcast a packet including the inertial information 510 without maintaining a connection with other nearby electronic devices, thereby reducing power consumption required to perform an operation of providing the inertial information 510 to other nearby electronic devices.

Electronic devices located in the surroundings of the external electronic device 400 may obtain the inertial information 510 transmitted by the external electronic device 400. In an embodiment of the disclosure, the electronic device 100 may also obtain the inertial information 510 provided by the external electronic device 400 through the communication interface 160.

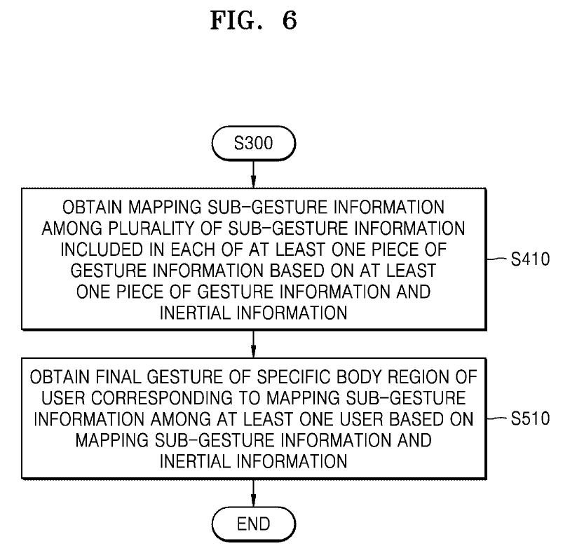

FIG. 6 is a flowchart illustrating an example operation of obtaining mapping sub-gesture information corresponding to a specific body region in which an external electronic device in which inertial information is generated is located among a plurality of sub-gesture information according to various embodiments. Hereinafter, the same reference numerals are assigned to the same operations as the operations described with reference to FIG. 3, and redundant descriptions may not be repeated here.

Referring to FIGS. 1, 2, 3, and 6, in an embodiment of the disclosure, a method of operating the electronic device 100 may include operation S410 of obtaining the mapping sub-gesture information corresponding to the specific body region in which the external electronic device 400 is located among the plurality of sub-gesture information included in each of at least one piece of gesture information based on the least one gesture information and the inertial information.

In operation S410, the at least one processor 140 may execute instructions or program codes of the gesture mapping module 134 to cause the electronic device 100 to obtain the mapping sub-gesture information corresponding to the specific body region in which the external electronic device 400 is located among the plurality of sub-gesture information included in each of the at least one piece of gesture information based on the least one gesture information and the inertial information.

In an embodiment of the disclosure, operation S410 may be performed after operation S300.

In an embodiment of the disclosure, the method of operating the electronic device 100 may include operation S510 of obtaining a final gesture of a specific body region of a user corresponding to the mapping sub-gesture information among the at least one user based on the mapping sub-gesture information and the inertial information.

In operation S510, the at least one processor 140 may execute instructions or program codes of the final gesture obtaining module 135 to cause the electronic device 100 to obtain the final gesture of the user's specific body region corresponding to the mapping sub-gesture information among the at least one user based on the mapping sub-gesture information and the inertial information.

In an embodiment of the disclosure, referring to FIGS. 4 and 5, in operation S510, the electronic device 100 may obtain a final gesture by the left wrist 500 or the left hand of the third user 320.

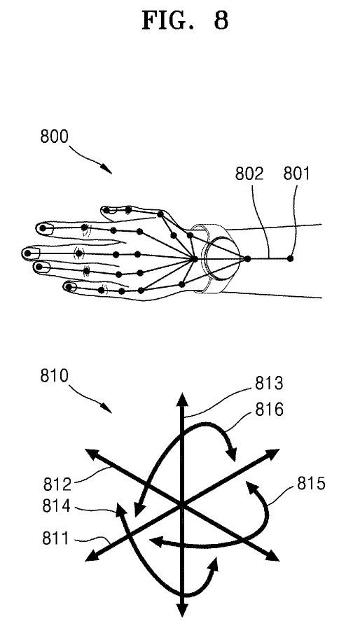

FIG. 7 is a flowchart illustrating an example operation of comparing inertial information with sub-gesture information corresponding to a preset reference body region among gesture information according to various embodiments. FIG. 8 is a diagram illustrating an example operation of comparing inertial information with sub-gesture information corresponding to a preset reference body region among gesture information according to various embodiments. Hereinafter, the same reference numerals are assigned to the same operations as the operations described with reference to FIG. 3, and redundant descriptions may not be repeated here.

Referring to FIGS. 2, 3, 4, and 7, in an embodiment of the disclosure, a method of operating the electronic device 100 may include operation S310 of selecting at least one piece of sub-gesture information corresponding to the preset reference body region from among a plurality of sub-gesture information included in each of at least one piece of gesture information. In an embodiment of the disclosure, operation S310 may be performed after operation S300.

In an embodiment of the disclosure, the "reference body region" may be a preset region among a plurality of body regions of a person in which it is determined that the external electronic device 400 may be located. In an embodiment of the disclosure, the reference body region may be previously set to include a region expected to be a place where a person may wear the external electronic device 400, for example, a hand region including a finger capable of wearing a smart ring, a wrist region capable of wearing a smart watch, an ear region capable of wearing earphones or headphones, a head region capable of wearing a head mounted display device, etc. However, the disclosure is not limited thereto, and the reference body region may be set to further include other regions. In addition, the size of a region to be set may also vary just as the hand region and the wrist region may be divided into one region.

In operation S310, the at least one processor 140 may execute instructions or program codes of the memory 130 to cause the electronic device 100 to select the at least one piece of sub-gesture information corresponding to the preset reference body region from among the plurality of sub-gesture information included in each of the at least one piece of gesture information.

In an embodiment of the disclosure, when the reference body region includes the hand region, the wrist region, and the ear region, the electronic device 100 may select three sub-gesture information respectively corresponding to the hand region, the wrist region, and the ear region from among the plurality of sub-gesture information included in each of the at least one piece of gesture information. However, when no sub-gesture information corresponds to the reference body region among the plurality of sub-gesture information, the electronic device 100 may not select information corresponding to the corresponding region.

In an embodiment of the disclosure, the method of operating the electronic device 100 may include operation S420 of obtaining mapping sub-gesture information corresponding to a specific body region among the selected at least one piece of sub-gesture information included in each of the at least one piece of gesture information based on the selected at least one piece of sub-gesture information and the inertial information. In this regard, operation S420 may be included in operation S410.

In operation S420, the at least one processor 140 may execute instructions or program codes of the gesture mapping module 134 to cause the electronic device 100 to obtain the mapping sub-gesture information corresponding to the specific body region among the selected at least one piece of sub-gesture information included in each of the at least one piece of gesture information based on the selected at least one piece of sub-gesture information and the inertial information.

In an embodiment of the disclosure, FIG. 8 shows sub-gesture information 800 corresponding to the reference body region including a left hand and a wrist among the plurality of sub-gesture information. The sub-gesture information 800 includes a plurality of feature points 801 and lines 802 connecting the plurality of feature points 801.

FIG. 8 also shows inertial information 810 obtained by the electronic device 100. The inertial information 810 may include a 6DoF value, and may include an x-axis acceleration value 811, a y-axis acceleration value 812, a z-axis acceleration value 813, a roll angular velocity value 814, a pitch angular velocity value 815, and a yaw angular velocity value 816.

In an embodiment of the disclosure, the electronic device 100 may compare an x-axis acceleration value of the one sub-gesture information 800 with the x-axis acceleration value 811 included in the inertial information 810 based on linear movement information in the one sub-gesture information 800 in the x-axis. The electronic device 100 may compare a y-axis acceleration value of the one sub-gesture information 800 with the y-axis acceleration value 812 included in the inertial information 810 based on linear movement information included in the one sub-gesture information 800 in the y-axis. The electronic device 100 may compare a z-axis acceleration value of the one sub-gesture information 800 with the z-axis acceleration value 813 included in the inertial information 810 based on linear movement information included in the one sub-gesture information 800 in the z-axis.

In an embodiment of the disclosure, the electronic device 100 may compare a roll angular velocity value of one sub-gesture information 800 with the roll angular velocity value 814 included in the inertial information 810 based on rotational motion information included in the one sub-gesture information 800 with respect to the x-axis. The electronic device 100 may compare a pitch angular velocity value of one sub-gesture information 800 with the pitch angular velocity value 815 included in the inertial information 810 based on rotational motion information included in the one sub-gesture information 800 with respect to the y-axis. The electronic device 100 may compare a yaw angular velocity value of one sub-gesture information 800 with the yaw angular velocity value 816 included in the inertial information 810 based on rotational motion information included in the one sub-gesture information 800 with respect to the z-axis.

In an embodiment of the disclosure, the electronic device 100 may determine sub-gesture information having the smallest difference from the inertial information 810 among the plurality of sub-gesture information as mapping sub-gesture information. In this regard, the smallest difference may refer, for example, to a body region corresponding to the sub-gesture information is the same region as a body region in which the external electronic device 400 providing the inertial information 810 is located.

On the other hand, among the plurality of sub-gesture information, the remaining sub-gesture information corresponding to a body region different from the body region in which the external electronic device 400 providing the inertial information 810 is located may be significantly different from the inertial information 810.

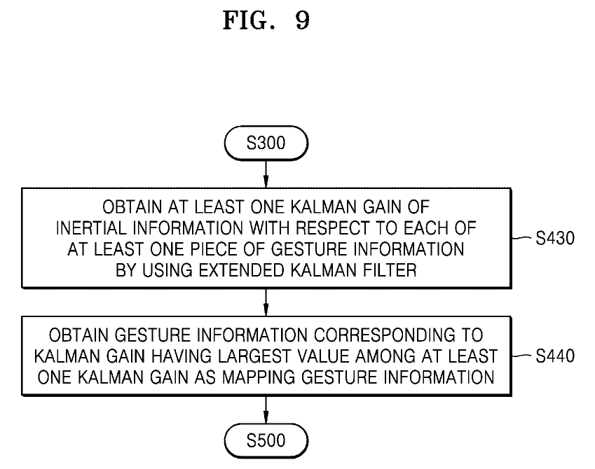

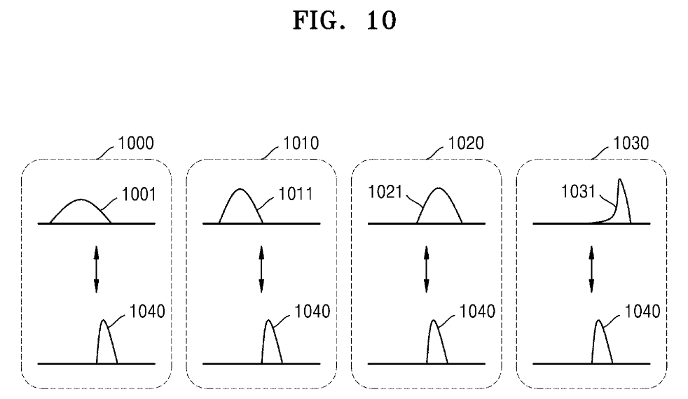

Hereinafter, operations of the electronic device 100 in operations S400, S410, and S420 will be described in greater detail below with reference to FIGS. 9 and 10.

FIG. 9 is a flowchart illustrating an example operation of obtaining mapping gesture information based on at least one piece of gesture information and inertial information using an extended Kalman filter according to various embodiments. Hereinafter, the same reference numerals are assigned to the same operations as the operations described with reference to FIG. 3, and redundant descriptions may not be repeated here.

Referring to FIGS. 2, 3, and 9, in an embodiment of the disclosure, a method of operating the electronic device 100 may include operation S430 of obtaining at least one Kalman gain of the inertial information with respect to each of the at least one piece of gesture information using the extended Kalman filter.

In an embodiment of the disclosure, operation S430 may be performed after operation S300. In addition, operation S430 may be included in operation S400.

In an embodiment of the disclosure, the "extended Kalman filter" may refer to a recursive filter that estimates the state of a nonlinear system based on a measured value including noise. The extended Kalman filter may predict the current predicted value based on a previously obtained estimated value and a model of a pre-designed nonlinear system in consideration of a system in which the extended Kalman filter is used. The extended Kalman filter may be an algorithm for obtaining an estimated value of the current state by updating the current predicted value such that a residual of the current predicted value and the obtained current measured value is reflected.

In an embodiment of the disclosure, the "Kalman gain" may refer to a weight that determines the degree to which the residual of the predicted value and the measured value is reflected in updating the current predicted value such that the residual of the current predicted value and the current measured value is reflected through the extended Kalman filter.

In an embodiment of the disclosure, the smaller the noise included in the current measured value, the greater the value of the Kalman gain. The greater the noise included in the current measured value, the smaller the value of the Kalman gain.

In an embodiment of the disclosure, the greater the value of the Kalman gain, the higher the degree to which the current measured value is reflected in the current estimated value. The smaller the value of the Kalman gain, the lower the degree to which the current measured value is reflected in the current estimated value.

In an embodiment of the disclosure, the electronic device 100 may use the Kalman gain included in the extended Kalman filter in an operation of obtaining the mapping gesture information corresponding to the inertial information among the at least one piece of gesture information.

In operation S430, the at least one processor 140 may execute instructions or program codes of the gesture mapping module 134 to cause the electronic device 100 to obtain at least one Kalman gain of the inertial information with respect to each of the at least one piece of gesture information.

In an embodiment of the disclosure, the electronic device 100 may obtain at least one current predicted value using the at least one piece of gesture information of each of the at least one user using the electronic device 100 as a previous measured value with respect to the extended Kalman filter. The electronic device 100 may use the inertial information obtained through the communication interface 160 as the current measured value. Accordingly, the electronic device 100 may obtain the at least one Kalman gain of the inertial information with respect to each of the at least one piece of gesture information.

In an embodiment of the disclosure, the method of operating the electronic device 100 may include operation S440 of obtaining gesture information corresponding to a Kalman gain having the largest value among the at least one Kalman gain as mapping gesture information. In an embodiment of the disclosure, operation S440 may be included in operation S400.

In an embodiment of the disclosure, because each of the at least one user has a different movement, position, or shape, information having a different value may be included in the at least one piece of gesture information. The inertial information may include information about a movement of a user wearing the external electronic device 400. Accordingly, the at least one Kalman gain of the inertial information with respect to each of the at least one piece of gesture information may have different values.

However, the disclosure is not limited thereto, and when only one user uses the electronic device 100, one gesture information may be obtained by the electronic device 100, and a Kalman gain of the inertial information about the gesture information may also have one value.

In an embodiment of the disclosure, a residual between the current predicted value and the current measured value by the gesture information obtained from the user wearing the external electronic device 400 among the at least one user may be referred to as a first residual. A residual between the current predicted value and the current measured value by gesture information obtained from a user different from the user wearing the external electronic device 400 among the at least one user may be referred to as a second residual.

The first residual may refer to a residual between the current predicted value and the current measured value obtained based on the same movement of the same user, and may have the smallest value among at least one residual. The second residual may refer to a residual between the current predicted value and the current measured value obtained based on movements of different users that may be different from each other, and may have a value greater than that of the first residual.

In an embodiment of the disclosure, when the gesture information and the inertial information are obtained from the same user, the inertial information may be valid information, rather than noise information, with respect to the gesture information in obtaining a gesture of the corresponding user. When the gesture information and the inertial information are obtained from different users, the inertial information may be noise information with respect to the gesture information in obtaining a gesture of the corresponding user.

In an embodiment of the disclosure, when the gesture information and the inertial information are obtained from the same user, the accuracy of the obtained gesture may be increased in consideration of the gesture information and the inertial information together. On the other hand, when the gesture information and the inertial information are obtained from different users, the accuracy of the obtained gesture may be decreased in consideration of the gesture information and the inertial information together.

Therefore, the greater the residual between the current predicted value and the current measured value, the greater the noise included in the current measured value, and thus the value of the Kalman gain of the inertial information with respect to the gesture information obtained through the extended Kalman filter may be small. The smaller the residual between the current predicted value and the current measured value, the smaller the noise included in the current measured value, and thus the value of the Kalman gain of the inertial information with respect to the gesture information obtained through the extended Kalman filter may be great. In this regard, when the value of the Kalman gain is the largest may be when the residual is the smallest because the gesture information and the user inertial information are obtained from the same user.

In operation S440, the at least one processor 140 may execute instructions or program codes of the gesture mapping module 134 to cause the electronic device 100 to obtain the gesture information corresponding to the Kalman gain having the largest value among the at least one Kalman gain as the mapping gesture information.

However, the disclosure is not limited thereto. The above description may relate to an embodiment in which inertial information transmitted from one external electronic device in the surroundings of the electronic device 100 is obtained through the communication interface 160. In an embodiment of the disclosure, the electronic device 100 may obtain a plurality of inertial information transmitted from each of two or more nearby external electronic devices. In this case, the electronic device 100 may perform operations S430 and S440 on each of the plurality of inertial information. The electronic device 100 may obtain the gesture information corresponding to a Kalman gain having the largest value among the at least one Kalman gain as the mapping gesture information corresponding to each of the plurality of inertial information.

In an embodiment of the disclosure, operation S500 (see, e.g., FIG. 3) may be performed after operation S440.

In an embodiment of the disclosure, the extended Kalman filter may be used to obtain a desired result by fusing data obtained from different types of sensors. In operation S500, the at least one processor 140 may execute instructions or program codes of the final gesture obtaining module 125 to cause the electronic device 100 to obtain a final gesture from the mapping gesture information and the inertial information using the extended Kalman filter.

In an embodiment of the disclosure, the electronic device 100 may use mapping gesture information obtained at a first time as a measured value, and obtain an estimated value of the first time by updating an initial predicted value based on the Kalman gain and a difference between a predicted value of an initial state and the mapping gesture information obtained at the first time. The electronic device 100 may use inertial information obtained at a second time as a measured value, and obtain an estimated value of the second time by updating a predicted value of the second time based on the Kalman gain and a difference between the estimated value of the second time obtained based on the estimated value of the first time and a system model and the inertial information obtained at the second time. In this regard, the predicted value of the initial state may be set to an arbitrary value. In addition, the inertial information may be used as a measured value at the first time, and the mapping gesture information may be used as a measured value at the second time.

In an embodiment of the disclosure, the electronic device 100 may repeatedly perform the above operation based on the mapping gesture information and inertial information obtained at a plurality of times to obtain a finally obtained estimated value as a final gesture of a user.

In an embodiment of the disclosure, the at least one piece of gesture information may include a plurality of sub-gesture information corresponding to each of a plurality of body regions.

In an embodiment of the disclosure, operation S430 may include an operation of obtaining at least one Kalman gain of inertial information with respect to each of the plurality of sub-gesture information included in each gesture information using the extended Kalman filter.

In an embodiment of the disclosure, the at least one processor 140 may execute instructions or program codes of the gesture mapping module 134 to cause the electronic device 100 to obtain the at least one Kalman gain of the inertial information with respect to each of the plurality of sub-gesture information included in each gesture information. Accordingly, the electronic device 100 may determine which body region is worn by the external electronic device 400 among the plurality of body regions of the user using the electronic device 100.

In an embodiment of the disclosure, operation S440 may include an operation of obtaining sub-gesture information corresponding to the Kalman gain having the largest value among the at least one Kalman gain as mapping sub-gesture information.

In an embodiment of the disclosure, the at least one processor 140 may execute instructions or program codes of the gesture mapping module 134 to cause the electronic device 100 to obtain the sub-gesture information corresponding to the Kalman gain having the largest value among the at least one Kalman gain as the mapping sub-gesture information.

In an embodiment of the disclosure, the electronic device 100 may determine a user wearing the external electronic device 400 among at least one user using the electronic device 100, through an operation of comparing inertial information obtained through the communication interface 160 with gesture information by a user image obtained through the camera 120.

The electronic device 100 may obtain sub-gesture information obtained from a user image of a body region corresponding to a position at which the external electronic device 400 is worn as the mapping sub-gesture information, among a plurality of sub-gesture information obtained from a user image of a plurality of body regions of a user wearing the external electronic device 400, through an operation of comparing the inertial information with each of the plurality of sub-gesture information respectively corresponding to the plurality of body regions included in the gesture information.

In an embodiment of the disclosure, operation S500 (see, e.g., FIG. 3) may include an operation of obtaining a final gesture from the mapping sub-gesture information and the inertial information using the extended Kalman filter. The electronic device 100 may obtain the final gesture from the mapping sub-gesture information and the inertial information using the extended Kalman filter.

In an embodiment of the disclosure, in obtaining a gesture of a body region corresponding to the mapping sub-gesture information, the electronic device 100 may obtain the gesture using not only sub-gesture information obtained from a user image of the corresponding body region but also inertial information obtained from the external electronic device 400 located in the corresponding body region. Accordingly, the electronic device 100 may obtain a high-accuracy gesture recognition result in which both the user image through the camera 120 and the inertial information through an inertial measurement sensor of the external electronic device 400 are considered.

FIG. 10 is a diagram illustrating an example operation of obtaining mapping gesture information based on at least one piece of sub-gesture information corresponding to a preset reference body region among a plurality of sub-gesture information and inertial information, according to various embodiments.

Referring to FIGS. 2, 7, 8, and 10, in an embodiment of the disclosure, FIG. 10 shows the operation of the electronic device 100 when four users use the electronic device 100 and obtain inertial information 1040 through the communication interface 160 of the electronic device 100. However, the disclosure is not limited thereto, and the electronic device 100 may be used by a different number of users (e.g., one person or five persons) from four. The electronic device 100 may further obtain other inertial information obtained from other external electronic devices in addition to the inertial information 1040. In this case, the electronic device 100 may perform an operation using the inertial information 1040 with respect to other inertial information.

In an embodiment of the disclosure, the electronic device 100 may obtain gesture information of each of the four users based on user images obtained by capturing images of the four users.

In an embodiment of the disclosure, the gesture information of each of the four users may include the plurality of sub-gesture information respectively corresponding to a plurality of body regions of a person.

In an embodiment of the disclosure, the electronic device 100 may obtain the inertial information 1040 through the communication interface 160. In this regard, the external electronic device 400 is located at a specific body region of any one of the four users, and thus the inertial information 1040 may be obtained by measuring a change in inertia according to a movement of the corresponding user.

In an embodiment of the disclosure, the electronic device 100 may obtain a plurality of Kalman gains of inertial information with respect to each of the plurality of sub-gesture information included in gesture information of each of the four users using an extended Kalman filter. The electronic device 100 may obtain sub-gesture information corresponding to a Kalman gain having the largest value among a plurality of Kalman gains as mapping sub-gesture information corresponding to the inertial information 1040.

In an embodiment of the disclosure, the electronic device 100 may select at least one piece of sub-gesture information corresponding to a preset reference body region from among the plurality of sub-gesture information included in each gesture information. The electronic device 100 may obtain at least one Kalman gain of inertial information with respect to each of the selected at least one piece of sub-gesture information using the extended Kalman filter. The electronic device 100 may obtain sub-gesture information corresponding to a Kalman gain having the largest value among the at least one Kalman gain as the mapping sub-gesture information corresponding to the inertial information 1040.

The at least one piece of sub-gesture information selected to correspond to the reference body region is used rather than a plurality of sub-gesture information, and thus the amount of operation of the electronic device 100 required to obtain the mapping sub-gesture information may be reduced.

In an embodiment of the disclosure, FIG. 10 shows four sub-gesture information 1001, 1011, 1021, and 1031 which are selected corresponding to a left hand region included in the reference body region among a plurality of body regions of the four users and the inertial information 1040. In this regard, another body region may be included in the reference body region, and in this case, the electronic device 100 may obtain a Kalman gain using sub-gesture information which are selected corresponding to the other body region and inertial information.

The four users may be referred to as a first user, a second user, a third user, and a fourth user, and the four sub-gesture information 1001, 1011, 1021, and 1031 may be respectively referred to as first sub-gesture information 1001 corresponding to the first user, second sub-gesture information 1011 corresponding to the second user, third sub-gesture information 1021 corresponding to the third user, and fourth sub-gesture information 1031 corresponding to the fourth user.

In an embodiment of the disclosure, a first case 1000 may be an operation of obtaining the first sub-gesture information 1001 and a Kalman gain of the inertial information 1040 using an extended Kalman filter. A second case 1010 may be an operation of obtaining the second sub-gesture information 1011 and a Kalman gain of the inertial information 1040 using the extended Kalman filter. A third case 1020 may be an operation of obtaining the third sub-gesture information 1021 and a Kalman gain of the inertial information 1040 using the extended Kalman filter. A fourth case 1030 may be an operation of obtaining the fourth sub-gesture information 1031 and a Kalman gain of the inertial information 1040 using the extended Kalman filter.

In an embodiment of the disclosure, a value of the residual between the third sub-gesture information 1021 and the inertial information 1040 in the third case 1020 may be smaller than a value of the residual in each of the first case 1000, the second case 1010, and the fourth case 1030. A value of the Kalman gain of the inertial information 1040 with respect to the third sub-gesture information 1021 in the third case 1020 may be greater than a value of the Kalman gain of the inertial information 1040 in each of the first case 1000, the second case 1010, and the fourth case 1030.

In an embodiment of the disclosure, the electronic device 100 may determine the third sub-gesture information 1021 having the largest value of the Kalman gain of the inertial information 1040 as mapping sub-gesture information among the first to fourth sub-gesture information 1001, 1011, 1021, and 1031. Accordingly, in obtaining gestures of the four users using the electronic device 100, the electronic device 100 may obtain the gesture by a left hand region of the third user using the inertial information 1040 as well as the third sub-gesture information 1021.

In this regard, the value of the Kalman gain of the inertial information 1040 in the third case 1020 may be greater than the value of the Kalman gain between the inertial information 1040 and sub-gesture information corresponding to another body region than the left hand region among a plurality of body regions.

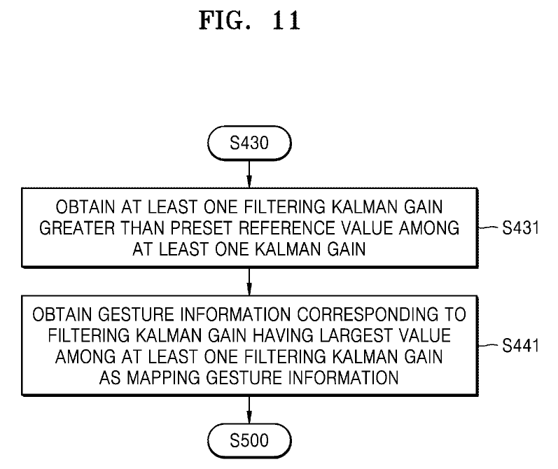

FIG. 11 is a flowchart illustrating an example operation of obtaining gesture information corresponding to a filtering Kalman gain having the largest value among at least one filtering Kalman gain greater than a preset reference value, as mapping gesture information, according to various embodiments. Hereinafter, the same reference numerals are assigned to the same operations as the operations described with reference to FIG. 9, and redundant descriptions may not be repeated here.

Referring to FIGS. 1, 2, 3, 9, and 11, in an embodiment of the disclosure, a method of operating the electronic device 100 may include operation S431 of obtaining the at least one filtering Kalman gain greater than the preset reference value among at least one Kalman gain.

In an embodiment of the disclosure, operation S431 may be performed after operation S430. In addition, operation S431 may be included in operation S400.

In an embodiment of the disclosure, the "reference value" may be a value set to use only inertial information having a higher Kalman gain than the corresponding value for the accuracy of a gesture recognized through the electronic device 100, even considering noise included in the inertial information obtained through the communication interface 160, noise due to a distance between the external electronic device 400 and the electronic device 100, or noise included in gesture information obtained by the electronic device 100 through a user image.

In operation S431, the at least one processor 140 may execute instructions or program codes of the gesture mapping module 134 to cause the electronic device 100 to obtain the at least one filtering Kalman gain greater than the preset reference value among the at least one Kalman gain.

In an embodiment of the disclosure, the method of operating the electronic device 100 may include operation S441 of obtaining the gesture information corresponding to the filtering Kalman gain having the largest value among the at least one filtering Kalman gain as the mapping gesture information. In an embodiment of the disclosure, operation S441 may be included in operation S400.

In operation S441, the at least one processor 140 may execute instructions or program codes of the gesture mapping module 134 to cause the electronic device 100 to obtain the gesture information corresponding to the filtering Kalman gain having the largest value among the at least one filtering Kalman gain as the mapping gesture information.

In an embodiment of the disclosure, the electronic device 100 may not obtain the gesture information corresponding to the Kalman gain having the largest value among the at least one Kalman gain as the mapping gesture information when the corresponding Kalman gain is lower than the reference value. In this case, even though the inertial information is obtained through the communication interface 160, the electronic device 100 may determine that the inertial information does not correspond to at least one piece of gesture information obtained from the user image (e.g. the inertial information includes a lot of noise components or the inertial information is transmitted from an external electronic device worn by another user who does not use the electronic device 100) and not use the inertial information in obtaining a gesture of a user.

Accordingly, the electronic device 100 may increase the accuracy and confidence of an operation of obtaining the gesture of the user.

In an embodiment of the disclosure, operation S500 may be performed after operation S441.

In an embodiment of the disclosure, operation S431 may include an operation of obtaining at least one sub-filtering Kalman gain greater than a preset reference value among a plurality of sub-gesture information included in each of the at least one piece of gesture information.

In an embodiment of the disclosure, operation S441 may include an operation of obtaining sub-gesture information corresponding to a sub-filtering Kalman gain having the largest value among the at least one sub-filtering Kalman gain as mapping sub-gesture information.

In an embodiment of the disclosure, the electronic device 100 may not obtain the gesture information corresponding to the Kalman gain having the largest value among the at least one Kalman gain as the mapping sub-gesture information when the corresponding Kalman gain is lower than the reference value. In this case, even though the inertial information is obtained through the communication interface 160, the electronic device 100 may determine that the inertial information does not correspond to at least one piece of sub-gesture information obtained from the user image (e.g. the inertial information includes a lot of noise components, the inertial information is transmitted from an external electronic device worn by another user who does not use the electronic device 100, or a position of the external electronic device is a different body region from a plurality of body regions included in the user image) and not use the inertial information in obtaining the gesture of the user.

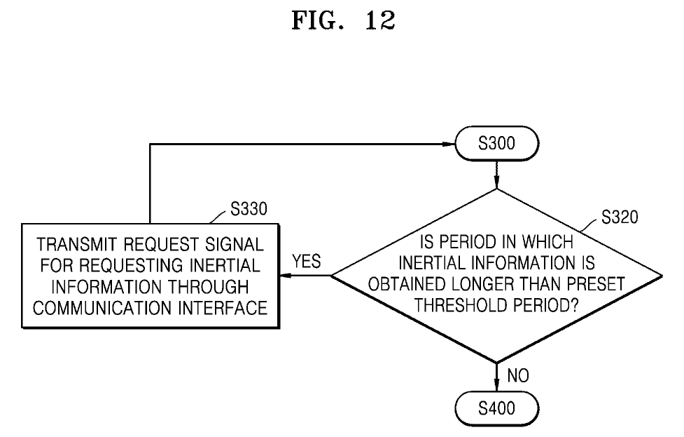

FIG. 12 is a flowchart illustrating an example operation for an electronic device to transmit a request signal for requesting inertial information when a period in which the inertial information is obtained is longer than a preset threshold period according to various embodiments. FIG. 13 is a diagram illustrating an example operation for an electronic device to obtain inertial information transmitted in a broadcast manner and an operation for the electronic device to request the inertial information according to various embodiments. Hereinafter, the same reference numerals are assigned to the same operations as the operations described with reference to FIG. 3, and redundant descriptions may not be repeated here.

Referring to FIGS. 1, 2, 3, and 12, in an embodiment of the disclosure, a method of operating the electronic device 100 may include operation S320 of determining whether the period in which the inertial information is obtained is longer than the preset threshold period.

In an embodiment of the disclosure, operation S320 may be performed after operation S300.

In an embodiment of the disclosure, the inertial information may be transmitted by the external electronic device 400 in the broadcast manner. The period in which the external electronic device 400 transmits the inertial information may be gradually increased. The external electronic device 400 may reduce power consumption of the operation of transmitting the inertial information by gradually increasing the period of transmitting the inertial information.

In an embodiment of the disclosure, the "threshold period" may refer to a period which is set for the electronic device 100 to obtain a final gesture of a user so that the electronic device 100 may use the inertial information in obtaining the final gesture.

In operation S320, the at least one processor 140 may execute instructions or program codes of the memory 130 to cause the electronic device 100 to determine whether the period in which the inertial information is obtained is longer than the preset threshold cycle.

In an embodiment of the disclosure, in operation S320, when it is determined that the period in which the inertial information is obtained is equal to or shorter than the preset threshold period (No in operation S320), the electronic device 100 may perform operation S400.

In an embodiment of the disclosure, in operation S320, when the period in which the inertial information is obtained is longer than the preset threshold period (Yes in operation S320), the method of operating the electronic device 100 may include operation S330 of transmitting a request signal requesting the inertial information through the communication interface 160.

In an embodiment of the disclosure, the electronic device 100 may transmit the request signal to the surroundings in the broadcast manner through the communication interface 160. The electronic device 100 may broadcast the request signal included in an advertising packet of BLE through the communication interface 160. The electronic device 100 may broadcast the request signal included in an advertising packet of Wi-Fi Aware through the communication interface 160. However, the disclosure is not limited thereto, and the electronic device 100 may use various communication methods capable of providing the request signal to nearby external electronic devices that are not paired in the broadcast manner.

However, the disclosure is not limited thereto, and when the obtained inertial information includes information for identifying the external electronic device 400, such as a device address, a device name, or a device identifier of the external electronic device 400, the electronic device 100 may transmit the request signal including the corresponding identification information to the surroundings.

In operation S330, the electronic device 100 may transmit the request signal for requesting the inertial information through the communication interface 160. When a request signal is obtained through a communication interface included in the external electronic device 400, the external electronic device 400 may transmit the inertial information again at a shorter period than the threshold period through the communication interface.

Referring to FIGS. 2, 12, and 13, in an embodiment of the disclosure, FIG. 13 shows an electronic device 1310 disposed in a specific space 1300, a first user 1320 and a second user 1330 using the electronic device 1310, and a third user 1340 not using the electronic device 1310. In an embodiment of the disclosure, the third user 1340 may be located in a space divided from a space including the electronic device 1310, the first user 1320, and the second user 1330.

In an embodiment of the disclosure, the electronic device 1310 may obtain first gesture information corresponding to the first user 1320 and second gesture information corresponding to the second user 1330 based on user images obtained by capturing images of the first user 1320 and the second user 1330 using the electronic device 1310 with a camera.

In an embodiment of the disclosure, the second user 1330 may be wearing the first external electronic device 1331. The third user 1340 may be wearing a second external electronic device 1341. The first external electronic device 1331 may transmit first inertial information 1332 obtained according to a movement of a specific body region of the second user 1330 in which the first external electronic device 1331 is located to the surroundings in a broadcast manner. The second external electronic device 1341 may transmit second inertial information 1342 obtained according to a movement of a specific body region of the third user 1340 in which the second external electronic device 1341 is located to the surroundings in the broadcast manner.

In this regard, a period in which the first external electronic device 1331 transmits the first inertial information 1332 and a period in which the second external electronic device 1341 transmits the second inertial information 1342 may be gradually increased. The first external electronic device 1331 and the second external electronic device 1341 may reduce power consumption by gradually increasing the period for transmitting the first inertial information 1332 and the second inertial information 1342 to the outside.

In an embodiment of the disclosure, the electronic device 1310 may obtain the first inertial information 1332 and the second inertial information 1342 through a communication interface.

In an embodiment of the disclosure, the electronic device 1310 may obtain a Kalman gain of the first inertial information 1332 with respect to each of the first gesture information and the second gesture information using the extended Kalman filter. The electronic device 1310 may determine the second gesture information as mapping gesture information corresponding to the first inertial information 1332 because a value of the Kalman gain of the first inertial information 1332 with respect to the second gesture information is greater than a value of the Kalman gain of the first inertial information 1332 with respect to the first gesture information. In this case, the value of the Kalman gain of the first inertial information 1332 with respect to the second gesture information may be greater than a preset reference value.

In an embodiment of the disclosure, the electronic device 1310 may obtain a Kalman gain of the second inertial information 1342 with respect to each of the first gesture information and the second gesture information using the extended Kalman filter. The electronic device 1310 may determine that no gesture information corresponds to the second inertial information 1342 because a value of the Kalman gain of the second inertial information 1342 with respect to each of the first gesture information and the second gesture information is smaller than the reference value.

In an embodiment of the disclosure, the electronic device 1310 may obtain a gesture of the first user 1320 from the first gesture information. The electronic device 1310 may obtain a gesture of the second user 1330 from the second gesture information and the first inertial information 1332 using the extended Kalman filter. In this regard, the gesture of the second user 1330 obtained by fusing the second gesture information and the first inertial information 1332 may be referred to as a final gesture.

In an embodiment of the disclosure, when a period of the obtained first inertial information 1332 is longer than the threshold period, the electronic device 1310 may transmit a request signal 1311 requesting the first inertial information 1332 to the outside through the communication interface 160. In this regard, the request signal 1311 may be transmitted to the surroundings in the broadcast manner.

In an embodiment of the disclosure, the first external electronic device 1331 may obtain the request signal 1311 through a communication interface. The first external electronic device 1331 may confirm that a packet of the request signal 1311 includes information requesting the first inertial information 1332 and transmit the first inertial information 1332 to the outside at a shorter period than the threshold period.

In an embodiment of the disclosure, the second external electronic device 1341 may obtain the request signal 1311 through a communication interface. The second external electronic device 1341 may confirm that the packet of the request signal 1311 includes the information requesting the first inertial information 1332 rather than the second inertial information 1342 provided by the second external electronic device 1341, and ignore the request signal 1311.

FIG. 13 shows that the first to third users 1320, 1330, and 1340 are located in the specific space 1300, but the disclosure is not limited thereto. In an embodiment of the disclosure, only at least one user using the electronic device 1310 within the space including the electronic device 1310 may be located in the specific space 1300. In addition, two or more users within a space excluding the electronic device 1310 may be located in the specific space 1300.

In an embodiment of the disclosure, a plurality of external electronic devices may be located in the specific space 1300. Each of a plurality of users located in the specific space 1300 may be wearing an external electronic device. However, the disclosure is not limited thereto, and some of the plurality of users may not wear an external electronic device, and the remaining users may wear an external electronic device. In addition, one user may be wearing two or more external electronic devices on different body parts.

In an embodiment of the disclosure, the plurality of external electronic devices may respectively transmit a plurality of inertial information obtained according to a movement of a specific body region of each of a plurality of users in which the plurality of external electronic devices are located to the surroundings in a broadcast manner. In this regard, each of the plurality of inertial information may include information capable of identifying an external electronic device such as a device name or a device identifier of each of the plurality of corresponding external electronic devices.

In an embodiment of the disclosure, the electronic device 1310 may obtain the plurality of inertial information through a communication interface.

In an embodiment of the disclosure, the electronic device 1310 may obtain a user image by capturing an image of at least one user located in the space including the electronic device 1310 among a plurality of users with a camera. The electronic device 1310 may obtain at least one piece of gesture information corresponding to the at least one user located in the space including the electronic device 1310 based on the user image.

In an embodiment of the disclosure, the electronic device 1310 may compare the at least one piece of gesture information with the plurality of inertial information to obtain at least one inertial information corresponding to the at least one piece of gesture information among the plurality of inertial information. The electronic device 1310 may determine the at least one inertial information corresponding to the at least one piece of gesture information as at least one mapping inertial information.

In an embodiment of the disclosure, the electronic device 1310 may obtain a Kalman gain of each of the plurality of inertial information with respect to the at least one piece of gesture information using the extended Kalman filter, and determine at least one inertial information having the largest value among the obtained Kalman gains as the mapping inertial information. In this regard, when the electronic device 1310 obtains two or more gesture information respectively corresponding to two or more users, the electronic device 1310 may obtain a Kalman gain of each of the plurality of inertial information with respect to each of the two or more gesture information, and determine one inertial information having the largest value among the obtained Kalman gains as the mapping inertial information corresponding to each of the two or more gesture information.

In an embodiment of the disclosure, the electronic device 1310 may identify an external electronic device that has transmitted the mapping inertial information from among the plurality of external electronic devices through information such as a device name or a device identifier included in the mapping inertial information. In this regard, the external electronic device identified as having transmitted the mapping inertial information may be an external electronic device worn by a user located within the space including the electronic device 1310. The external electronic device identified as having transmitted the mapping inertial information may be referred to as an identification external electronic device. The electronic device 1310 may compare the at least one piece of gesture information with the plurality of inertial information to identify a user wearing an external electronic device among at least one user located in the space including the electronic device 1310.

In an embodiment of the disclosure, the electronic device 1310 may obtain a gesture of a user wearing the identification external electronic device from mapping inertial information obtained from the identification external electronic device. In this regard, the obtained gesture of the user may be a gesture using a specific body part wearing the identification external electronic device.

In an embodiment of the disclosure, the electronic device 1310 may control the operation of the electronic device 1310 based on the obtained gesture of the user.

However, in an embodiment of the disclosure, the gesture of the user obtained by using the mapping inertial information obtained from the identification external electronic device may include a drift error caused by accumulation of errors in the movement of the user and the measured inertial information over time.

In an embodiment of the disclosure, the electronic device 1310 may correct the drift error included in the gesture of the user using the gesture information determined to correspond to the mapping inertial information. The electronic device 1310 may correct the drift error by comparing the gesture of the user obtained from the gesture information with the gesture of the user obtained from the mapping inertial information. The electronic device 1310 may use the gesture of the user in which the drift error is corrected using the gesture information after using and obtaining the mapping inertial information.

In an embodiment of the disclosure, the electronic device 1310 may obtain a gesture of the user wearing the identification external electronic device from the gesture information and the mapping inertial information. In this case, the gesture of the user obtained from the gesture information and the mapping inertial information may be referred to as a final gesture. The electronic device 1310 may obtain the final gesture by fusing the gesture information and the mapping inertial information. The electronic device 1310 may control the operation of the electronic device 1310 based on the final gesture obtained from the gesture information and the mapping inertial information using the extended Kalman filter.

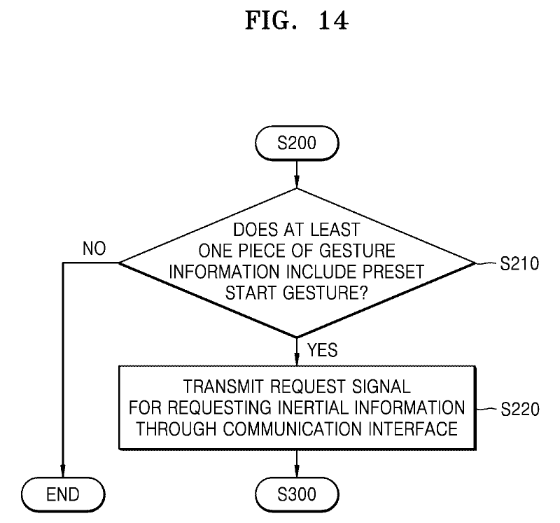

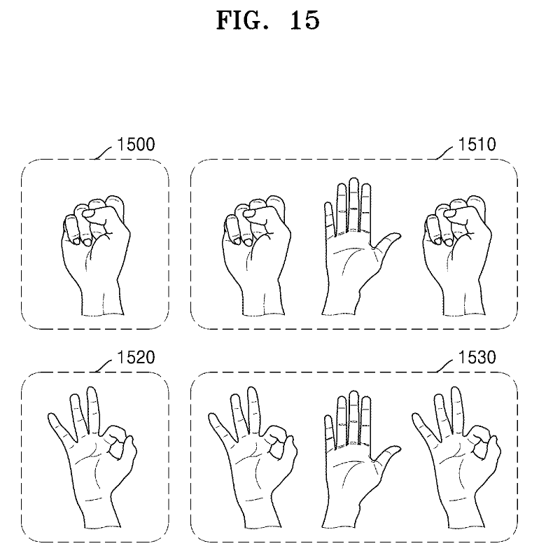

FIG. 14 is a flowchart illustrating an example operation for an electronic device to transmit a request signal for requesting inertial information when obtained gesture information includes a preset start gesture, according to various embodiments. FIG. 15 is a diagram illustrating an example preset start gesture for determining whether to perform the operation of the electronic device according to various embodiments. Hereinafter, the same reference numerals are assigned to the same operations as the operations described with reference to FIG. 3, and redundant descriptions may not be repeated here.

Referring to FIGS. 1, 2, 3, and 14, in an embodiment of the disclosure, a method of operating the electronic device 100 may include operation S210 of determining whether at least one piece of gesture information includes the preset start gesture.

In an embodiment of the disclosure, operation S210 may be performed after operation S200.

Referring to FIG. 15, in an embodiment of the disclosure, the "start gesture" may be a preset operation for the electronic device 100 to perform an operation of obtaining a gesture of a user using the electronic device 100 when the corresponding gesture is recognized. The start gesture may be a preset gesture for the electronic device 100 to transmit the request signal for requesting the inertial information to the surroundings of the electronic device 100 through the communication interface 160 when the corresponding gesture is recognized.

In an embodiment of the disclosure, the start gesture may include a first gesture 1500 in the form of a clenched fist, a second gesture 1510 in the form of a clenched fist, opening the hand, and then a clenched fist again, a third gesture 1520 in the form of touching the tip of the thumb on the tip of the index finger, and spreading the remaining fingers to indicate "OK", and a fourth gesture 1530 in the form of indicating "OK", opening the hand, and indicating "OK" again. However, this is an example, and the disclosure is not limited thereto, and may include other types of gestures. In addition, the start gesture may include a gesture using another body region, for example, the form of a mouth, in addition to the gesture using a hand.

In operation S210, the at least one processor 140 may execute instructions or program codes of the memory 130 to cause the electronic device 100 to determine whether the at least one piece of gesture information includes the preset start gesture. In this regard, the electronic device 100 may determine whether the start gesture is included in a gesture estimated from a user image through the gesture estimation module 132.

In an embodiment of the disclosure, in operation S210, when the at least one piece of gesture information includes the preset start gesture (Yes in operation S210), the method of operating the electronic device 100 may include operation S220 of transmitting the request signal for requesting the inertial information through the communication interface 160.

In operation S220, the electronic device 100 may transmit the request signal for requesting the inertial information through the communication interface 160.

In an embodiment of the disclosure, operation S300 may be performed after operation S220. In an embodiment of the disclosure, in operation S220, the external electronic device 400 may obtain the request signal transmitted by the electronic device 100 in a broadcast manner through the communication interface 160. When the external electronic device 400 transmits the inertial information to the surroundings in response to the request signal, in operation S300, the electronic device 100 may obtain the inertial information through the communication interface 160.

In an embodiment of the disclosure, in operation S210, when the at least one piece of gesture information does not include the preset start gesture (No in operation S210), the method of operating the electronic device 100 may end without transmitting the request signal. For example, the electronic device 100 may determine that it is not necessary to recognize or obtain the gesture of the user, and end the operation for obtaining the gesture of the user.

However, the disclosure is not limited thereto. The method of operating the electronic device 100 may further include an operation of determining whether an application executed in the electronic device 100 is a preset application or program (e.g., a game, a search window, a note, or a picture board) capable of receiving a gesture from the user using the electronic device 100 as an input, or whether the user uses a menu or function capable of performing a specific input using a gesture during an operation of the application executed in the electronic device 100.

The electronic device 100 may perform operation S220 when it is determined in the above operation that the electronic device 100 needs to obtain the gesture from the user.

FIG. 16 is a flowchart illustrating an example operation for an external electronic device to transmit inertial information when a preset start gesture is included in a gesture obtained based on the inertial information according to various embodiments.

Referring to FIGS. 1, 15, and 16, in an embodiment of the disclosure, a method of operating the external electronic device 400 may include operation S10 of obtaining the inertial information from at least one user using the external electronic device 400 using an inertial measurement sensor included in the external electronic device 400.

In operation S10, the external electronic device 400 may obtain the inertial information by measuring a change in inertial according to a movement of the body of the user wearing the external electronic device 400.

In an embodiment of the disclosure, the method of operating the external electronic device 400 may include an operation of obtaining a gesture of the user wearing the external electronic device 400 based on the obtained inertial information after operation S10. In an embodiment of the disclosure, the inertial information may include 6DoF information according to a movement of a body region wearing the external electronic device 400 or a movement of a peripheral region of the corresponding body region. The external electronic device 400 may compare previously stored reference inertial information with the inertial information to obtain the gesture of the user wearing the external electronic device 400.

The "reference inertial information" may include a plurality of inertial information obtained when a user performs each of a plurality of specific gestures, and the external electronic device 400 may determine that the user performs any one specific gesture corresponding to the inertial information among the plurality of specific gestures when it is determined that the obtained inertial information corresponds to any one of the plurality of inertial information included in the reference inertial information.

In an embodiment of the disclosure, when the external electronic device 400 is worn on the user's left wrist, first inertial information measured when the user rotates the left wrist clockwise may be stored as the reference inertial information. When the obtained inertial information corresponds to the first inertial information, the external electronic device 400 may determine that the user performs a gesture of rotating the left wrist clockwise.

When the user performs a specific gesture with the finger on the left hand, the left wrist may also move or vibration may be transmitted to the left wrist according to the movement of the finger due to the body structure. Therefore, second inertial information measured when the user performs a specific gesture with the finger of the left hand may also be stored as the reference inertial information. When the obtained inertial information corresponds to the second inertial information, the external electronic device 400 may determine that the user performs a specific gesture with the finger of the left hand.

In an embodiment of the disclosure, the method of operating the external electronic device 400 may include operation S20 of determining whether the obtained gesture of the at least one user is included in preset start gestures, e.g., 1500, 1510, 1520, and 1530, based on the inertial information.

In operation S20, the external electronic device 400 may determine whether the obtained gesture of the at least one user is included in the preset start gestures 1500, 1510, 1520, and 1530.

In operation S20, when it is determined that the obtained gesture of the at least one user is included in the start gesture (Yes in operation S20), the method of operating the external electronic device 400 may include operation S30 of transmitting the inertial information to the outside through a communication interface included in the external electronic device 400.

In operation S30, the external electronic device 400 may transmit the inertial information to the outside in a broadcast manner through the communication interface. In this regard, the external electronic device 400 may gradually set a period for transmitting the inertial information to the outside, thereby reducing the amount of power consumed to transmit the inertial information to the outside. Accordingly, the usage time of a battery included in the external electronic device 400 may be increased.

Thereafter, operation S100, which is an operation of the electronic device 100 according to the disclosure, may be performed. However, the disclosure is not limited thereto, and operation S300 according to the disclosure may be performed after operation S30.

In operation S20, when it is determined that the gesture of the at least one user is not included in the start gesture (No in operation S20), the method of operating the external electronic device 400 may end without transmitting the inertial information to the outside.

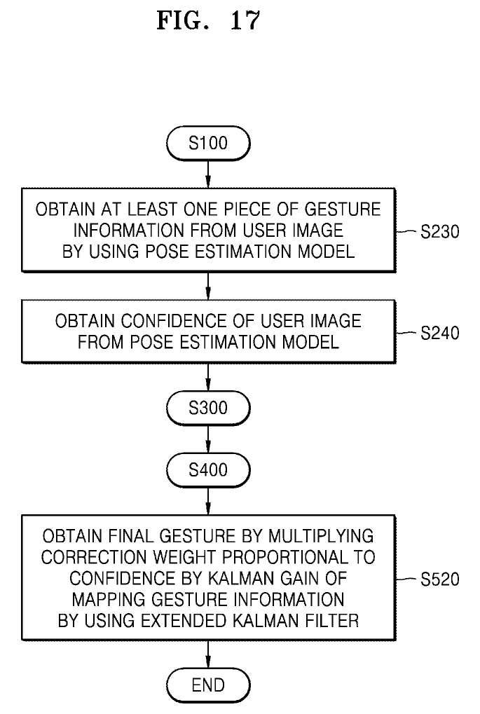

FIG. 17 is a flowchart illustrating an example operation for an electronic device to obtain a final gesture based on a correction weight proportional to the confidence of a user image obtained from a pose estimation model, according to various embodiments. Hereinafter, the same reference numerals are assigned to the same operations as the operations described with reference to FIGS. 3 and 9, and redundant descriptions may not be repeated here.

Referring to FIGS. 2, 3, 9, and 17, in an embodiment of the disclosure, a method of operating the electronic device 100 may include operation S230 of obtaining at least one piece of gesture information from the user image using the pose estimation model.

In an embodiment of the disclosure, operation S230 may be performed after operation S100. Operation S230 may be included in operation S200. The pose estimation model used in operation S230 may include the AI model 133 included in the gesture estimation module 132.

In operation S230, the at least one processor 140 may execute instructions or program codes of the gesture estimation module 132 to cause the electronic device 100 to obtain at least one piece of gesture information from the user image using the pose estimation model.

In an embodiment of the disclosure, the method of operating the electronic device 100 may include operation S240 of obtaining the confidence of the user image from the pose estimation model.

In an embodiment of the disclosure, the "confidence" obtained in operation S240 may be a value in which a degree of confidence with respect to the gesture information estimated by the pose estimation model used in operation S230 from the user image is expressed as a value between 0 and 1.

In an embodiment of the disclosure, the pose estimation model may generate a probability density function with respect to a coordinate in which each feature point of the gesture is located from the user image. The pose estimation model may estimate the coordinate having the highest value in the corresponding probability density function as the position of the corresponding feature point. In this regard, the confidence may refer to a probability density at the corresponding coordinate. However, the disclosure is not limited thereto, and the confidence may include other information that may be used to trust a result of the pose estimation model according to an algorithm of the pose estimation model used to obtain the gesture information in operation S230.

In an embodiment of the disclosure, the confidence may be high when the resolution of a user image obtained through the camera 120 is high, when a body region in which the gesture information included in the user image is obtained has a large area, or when the body region in which the gesture information included in the user image is obtained is not covered by an obstacle or other body region.

However, the confidence may be low when the resolution of the user image obtained through camera 120 is low, when the body region in which the gesture information included in the user image is obtained has a small area, or when the body region in which the gesture information included in the user image is obtained is covered by an obstacle or other body region.

In operation S240, the electronic device 100 may obtain the confidence of the user image from the pose estimation model.

In an embodiment of the disclosure, after operation S240, the electronic device 100 may perform operations S300 and S400.

In an embodiment of the disclosure, the method of operating the electronic device 100 may include operation 520 of obtaining a final gesture by multiplying the correction weight proportional to the confidence by a Kalman gain of mapping gesture information using an extended Kalman filter. In an embodiment of the disclosure, operation S520 may be performed after operation S400. Operation S520 may be included in operation S500.

In an embodiment of the disclosure, the "correction weight" may be a value multiplied by the Kalman gain of the mapping gesture information to determine a degree to which the mapping gesture information is reflected in obtaining the final gesture of a user using the extended Kalman filter. The correction weight may have a value between 0 and 1. As the value of the correction weight is closer to 0, the degree to which the mapping gesture information is reflected in obtaining the final gesture may decrease.

In an embodiment of the disclosure, the value of the correction weight may increase as the confidence increases. The value of the correction weight may decrease as the confidence decreases. Accordingly, when the confidence of the gesture information obtained from the user image is low, the electronic device 100 may increase the accuracy of the final gesture by lowering the rate at which the gesture information is reflected and increasing the rate at which the inertial information is reflected in obtaining the final gesture.

However, the disclosure is not limited thereto. The correction weight may be set to have a value of 1 when a value of the confidence is greater than a preset value of a first threshold confidence. The correction weight may be set to have a value close to 0 as the value of the correction weight decreases when the value of the confidence is equal to or less than the value of the first threshold confidence.

The correction weight may be set to have a value greater than 1 when the value of the confidence is greater than a preset value of a second threshold confidence. In this case, the accuracy of the final gesture may be increased by increasing the rate at which gesture information having high confidence is reflected and lowering the rate at which inertial information is reflected in obtaining the final gesture. In this case, the value of the second threshold confidence may be greater than the value of the first threshold confidence.

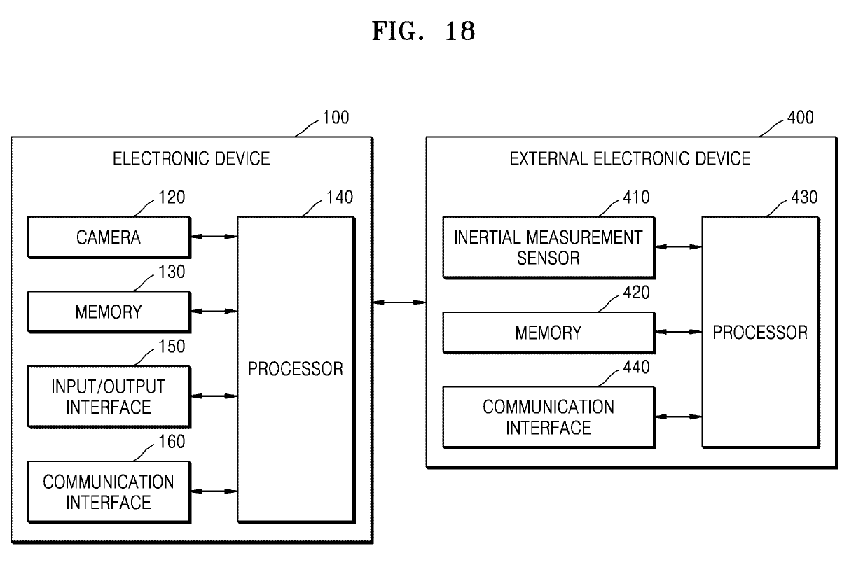

FIG. 18 is a block diagram illustrating example operations between an electronic device and an external electronic device according to various embodiments. Hereinafter, the same reference numerals are assigned to the same configurations as the configurations described with reference to FIG. 2, and redundant descriptions may not be repeated here.

Referring to FIGS. 2, 13, and 18, in an embodiment of the disclosure, the electronic device 100 may include the camera 120, the memory 130, the at least one processor (e.g., including processing circuitry) 140, the input/output interface (e.g., including input/output circuitry) 150, and the communication interface (e.g., including communication circuitry) 160.

In an embodiment of the disclosure, the external electronic device 400 may include an inertial measurement sensor 410, memory 420, at least one processor (e.g., including processing circuitry) 430, and a communication interface (e.g., including communication circuitry) 440.

However, not all of the components shown in FIG. 18 are essential components. The external electronic device 400 may be implemented with more or fewer components than in FIG. 18.

The inertial measurement sensor 410, the memory 420, the at least one processor 430, and the communication interface 440 included in the external electronic device 400 may be electrically connected to one another.

In an embodiment of the disclosure, the inertial measurement sensor 410 may include an acceleration sensor and an angular velocity sensor, for example, a gyroscope. The inertial measurement sensor 410 may obtain a 3DoF or 6DoF value by measuring an inertial change according to a movement of the external electronic device 400.

In an embodiment of the disclosure, instructions, a data structure, and program codes that are readable by the at least one processor 430 may be stored in the memory 420. In an embodiment of the disclosure, there may be one or more memories 420. Operations performed by the external electronic device 400 may be implemented to cause the at least one processor 430 to execute instructions or codes of a program stored in the memory 420.

In an embodiment of the disclosure, the memory 420 may not be separately present but may be configured to be included in the at least one processor 430. In an embodiment of the disclosure, various types of modules that may be used to perform operations of the external electronic device 400, for example, an inertial information obtaining module, etc. may be stored in the memory 420.

In an embodiment of the disclosure, the at least one processor 430, which includes a configuration to control a series of processes so that the external electronic device 400 operates, may include one or a plurality of processors. In an embodiment of the disclosure, the at least one processor 430 may execute various types of modules stored in the memory 420.

In an embodiment of the disclosure, the at least one processor 430 may be configured with at least one of a CPU, a microprocessor, a GPU, an AP, an ASIC, a DSP, a DSPD, a PLD, a FPGA, a CP, and/or an AI-only processor designed in a hardware structure specialized for learning and processing an AI model, but is not limited thereto.

Thus, the at least one processor 430 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

In an embodiment of the disclosure, the at least one processor 430 such as an SoC or an IC.

In an embodiment of the disclosure, the communication interface 440 may include various communication circuitry and perform data communication with a server outside or the electronic device outside by the control of the at least one processor 430.

For example, the communication interface 440 may perform data communication with the server outside or the electronic device outside using at least one of data communication types including, for example, WLAN, wireless LAN, Wi-Fi, Bluetooth, Zigbee, WFD, IrDA, BLE, NFC, Wibro, WiMAX, SWAP, WiGig, and RF communication.

In an embodiment of the disclosure, the communication interface 440 may provide the obtained inertial information to the server outside or the electronic device outside by the control of the at least one processor 430. The external electronic device 400 may provide the obtained inertial information to the server outside or the electronic device outside in a broadcast manner through the communication interface 440.

In an embodiment of the disclosure, the electronic device 100 may obtain user images by capturing images of a plurality of users using the electronic device 100 through the camera 120. The at least one processor 140 may execute instructions or program codes of the memory 130 to cause the electronic device 100 to obtain a plurality of gesture information respectively corresponding to the plurality of users from the user images.

In an embodiment of the disclosure, the electronic device 100 may obtain inertial information provided by the external electronic device 400 through the communication interface 160.

In an embodiment of the disclosure, the at least one processor 140 may execute instructions or program codes of the memory 130 to cause the electronic device 100 to obtain mapping gesture information corresponding to the inertial information from among the plurality of gesture information using an extended Kalman filter. In this regard, each of the plurality of gesture information may include a plurality of sub-gesture information corresponding to each of a plurality of body regions, and the electronic device 100 may obtain mapping sub-gesture information corresponding to the inertial information among the plurality of gesture information.

In an embodiment of the disclosure, the at least one processor 140 may execute instructions or program codes of the memory 130 to cause the electronic device 100 to obtain a final gesture of a user from the mapping gesture information or the mapping sub-gesture information and the inertial information using the extended Kalman filter.

According to an example embodiment, disclosure provides an electronic device. The electronic device may include a camera. The electronic device may include a communication interface. The electronic device may include memory storing a program or at least one instruction. The electronic device may include at least one processor. The at least one processor may be configured to individually or collectively execute the program or the at least one instruction stored in the memory to cause the electronic device to obtain a user image by capturing an image of at least one user using the electronic device through the camera. The electronic device may obtain at least one piece of gesture information corresponding to each of the at least one user by estimating a gesture from the user image. The electronic device may obtain inertial information from an external electronic device through the communication interface. The electronic device may obtain mapping gesture information corresponding to the inertial information from among the at least one piece of gesture information, based on the at least one piece of gesture information and the inertial information. The electronic device may obtain a final gesture for controlling the electronic device of a user corresponding to the mapping gesture information among the at least one user, based on the mapping gesture information and the inertial information.

In an example embodiment of the disclosure, the electronic device may obtain at least one Kalman gain of the inertial information with respect to each of the at least one piece of gesture information, using an extended Kalman filter. The electronic device may obtain gesture information corresponding to a Kalman gain having the largest value among the at least one Kalman gain as the mapping gesture information.

In an example embodiment of the disclosure, the electronic device may obtain at least one filtering Kalman gain greater than a preset reference value, among the at least one Kalman gain. The electronic device may obtain gesture information corresponding to a filtering Kalman gain having the largest value among the at least one filtering Kalman gain as the mapping gesture information.

In an example embodiment of the disclosure, the electronic device may obtain the final gesture from the mapping gesture information and the inertial information, using the extended Kalman filter.

In an example embodiment of the disclosure, the electronic device may obtain the at least one piece of gesture information from the user image, using a pose estimation model. The electronic device may obtain confidence of the user image from the pose estimation model. The electronic device may obtain the final gesture by multiplying a correction weight proportional to the confidence by the Kalman gain of the mapping gesture information, in using the extended Kalman filter.

In an example embodiment of the disclosure, the electronic device may obtain the inertial information transmitted from the external electronic device in a broadcast manner through the communication interface.

In an example embodiment of the disclosure, a period in which the inertial information is obtained through the communication interface may gradually increase. The electronic device may transmit a request signal for requesting the inertial information through the communication interface when the period is greater than a preset threshold period.

In an example embodiment of the disclosure, the at least one piece of gesture information may include a plurality of sub-gesture information respectively corresponding to a plurality of body regions. The electronic device may obtain mapping sub-gesture information corresponding to a specific body region in which the external electronic device is located, from among the plurality of sub-gesture information included in each of the at least one piece of gesture information, based on the at least one piece of gesture information and the inertial information. The electronic device may obtain the final gesture of the specific body region of a user corresponding to the mapping sub-gesture information among the at least one user, based on the mapping sub-gesture information and the inertial information.

In an example embodiment of the disclosure, the electronic device may select at least one piece of sub-gesture information corresponding to a preset reference body region from among the plurality of sub-gesture information included in each of the at least one piece of gesture information. The electronic device may obtain the mapping sub-gesture information corresponding to the specific body region among the selected at least one piece of sub-gesture information included in each of the at least one piece of gesture information, based on the selected at least one piece of sub-gesture information and the inertial information.

In an example embodiment of the disclosure, the electronic device may transmit a request signal for requesting the inertial information through the communication interface when the at least one piece of gesture information includes a preset start gesture.

According to an example embodiment, a method of operating an electronic device may include obtaining a user image by capturing an image of at least one user using the electronic device through a camera. The method may include obtaining at least one piece of gesture information corresponding to each of the at least one user by estimating a gesture from the user image. The method may include obtaining inertial information from an external electronic device through a communication interface. The method may include obtaining mapping gesture information corresponding to the inertial information among the at least one piece of gesture information, based on the at least one piece of gesture information and the inertial information. The method may include obtaining a final gesture for controlling the electronic device of a user corresponding to the mapping gesture information among the at least one user, based on the mapping gesture information and the inertial information.

In an example embodiment of the disclosure, the obtaining of the mapping gesture information may include obtaining at least one Kalman gain of the inertial information with respect to each of the at least one piece of gesture information, using an extended Kalman filter, the obtaining of the mapping gesture information may include obtaining gesture information corresponding to a Kalman gain having the largest value among the at least one Kalman gain as the mapping gesture information.

In an example embodiment of the disclosure, the obtaining of the mapping gesture information may include obtaining at least one filtering Kalman gain greater than a preset reference value, among the at least one Kalman gain. The obtaining of the mapping gesture information may include obtaining gesture information corresponding to a filtering Kalman gain having the largest value among the at least one filtering Kalman gain as the mapping gesture information.

In an example embodiment of the disclosure, the obtaining of the final gesture may include obtaining the final gesture from the mapping gesture information and the inertial information, using the extended Kalman filter.

In an example embodiment of the disclosure, the obtaining of the at least one piece of gesture information may include obtaining the at least one piece of gesture information from the user image, using a pose estimation model. The obtaining of the at least one piece of gesture information may include obtaining confidence of the user image from the pose estimation model. The obtaining of the final gesture may include obtaining the final gesture by multiplying a correction weight proportional to the confidence by the Kalman gain of the mapping gesture information, in using the extended Kalman filter.

In an example embodiment of the disclosure, in the obtaining of the inertial information, the inertial information transmitted from the external electronic device in a broadcast manner may be obtained through the communication interface, and a period in which the inertial information is obtained may gradually increase. The method may include transmitting a request signal for requesting the inertial information through the communication interface when the period is greater than a preset threshold period.

In an example embodiment of the disclosure, t the at least one piece of gesture information may include a plurality of sub-gesture information respectively corresponding to a plurality of body regions. The method may include obtaining mapping sub-gesture information corresponding to a specific body region in which the external electronic device is located among the plurality of sub-gesture information included in each of the at least one piece of gesture information, based on the at least one piece of gesture information and the inertial information. The method may include obtaining the final gesture of the specific body region of a user corresponding to the mapping sub-gesture information among the at least one user, based on the mapping sub-gesture information and the inertial information.

In an example embodiment of the disclosure, the method may include selecting at least one piece of sub-gesture information corresponding to a preset reference body region from among the plurality of sub-gesture information included in each of the at least one piece of gesture information. The obtaining of the mapping sub-gesture information may include obtaining the mapping sub-gesture information corresponding to the specific body region among the selected at least one piece of sub-gesture information included in each of the at least one piece of gesture information, based on the selected at least one piece of sub-gesture information and the inertial information.

In an example embodiment of the disclosure, the method may include transmitting a request signal for requesting the inertial information through the communication interface when the at least one piece of gesture information includes a preset start gesture.

According to an example, provided is a non-transitory computer-readable recording medium having recorded thereon a computer program, which, when executed by a computer, performs at least one operating method of various embodiments of the operating method of the electronic device.

The program executed by the electronic device described above herein may be implemented as a hardware component, a software component, and /or a combination of hardware components and software components. The program may be executed by any system capable of executing computer readable instructions.

The software may include a computer program, code, instructions, or a combination of one or more of the foregoing, and may include a processing device so that the processing device may operate as desired, or may independently or collectively instruction the processing device.

The software may be implemented as a computer program including instructions stored in computer-readable storage media. Examples of the computer-readable recording media include magnetic storage media (e.g., ROM, floppy disks, hard disks, etc.), and optical recording media (e.g., CD-ROMs, or digital versatile discs (DVDs)). The computer-readable recording media may be distributed over network coupled computer systems so that the computer-readable code is stored and executed in a distributive manner. These recording media may be read by the computer, stored in memory, and executed by a processor.

A computer-readable storage medium may be provided as a non-transitory storage medium. The 'non-transitory storage medium' is a tangible device and may not contain a signal (e.g., electromagnetic waves). This term does not distinguish a case in which data is stored semi-permanently in a storage medium from a case in which data is temporarily stored. For example, the non-transitory storage medium may include a buffer in which data is temporarily stored.

Programs according to various embodiments disclosed herein may be provided by being included in computer program products. The computer program product, which is a commodity, may be traded between sellers and buyers.

Computer program products may include a software program and a computer-readable storage medium having the software program stored thereon. For example, computer program products may include a product in the form of a software program (e.g., a downloadable application) that is electronically distributed through electronic device manufacturers or electronic markets (e.g., Samsung Galaxy Store). For electronic distribution, at least a portion of the software program may be stored on a storage medium or may be created temporarily. In this case, the storage medium may be a server of a manufacturer of an electronic device, a server of an electronic market, or a storage medium of a relay server for temporarily storing a software (SW) program.

While the disclosure has been particularly shown and described with reference to examples thereof, it will be understood by those of ordinary skill in the art that various changes in form and details may be made therein without departing from the spirit and scope of the disclosure including the following claims. For example, an appropriate result may be attained even when the above-described techniques are performed in a different order from the above-described method, and/or components, such as the above-described computer system or module, are coupled or combined in a different form from the above-described methods or substituted for or replaced by other components or equivalents thereof. It will also be understood that any of the embodiment(s) described herein may be used in conjunction with any other embodiment(s) described herein.

What is claimed is:

1. An electronic device comprising:
a camera;
a communication interface, comprising communication circuitry;
memory storing a program or at least one instruction; and
at least one processor comprising processing circuitry,
wherein at least one processor, individually and/or collectively, is configured to execute the program or the at least one instruction stored in the memory and to cause the electronic device to:
obtain a user image by capturing, through the camera, an image of at least one user using the electronic device,
obtain at least one piece of gesture information corresponding to each of the at least one user by estimating a gesture from the user image,
obtain inertial information from an external electronic device through the communication interface,
obtain mapping gesture information corresponding to the inertial information from among the at least one piece of gesture information, based on the at least one piece of gesture information and the inertial information, and
obtain a final gesture for controlling the electronic device of a user corresponding to the mapping gesture information among the at least one user, based on the mapping gesture information and the inertial information.

2. The electronic device of claim 1, wherein
the electronic device is configured to:
obtain at least one Kalman gain of the inertial information with respect to each of the at least one piece of gesture information using an extended Kalman filter, and
obtain gesture information corresponding to a Kalman gain having the largest value among the at least one Kalman gain as the mapping gesture information.

3. The electronic device of claim 2, wherein
the electronic device is further configured to:
obtain at least one filtering Kalman gain greater than a specified reference value, among the at least one Kalman gain, and
obtain gesture information corresponding to a filtering Kalman gain having the largest value among the at least one filtering Kalman gain as the mapping gesture information.

4. The electronic device of claim 2, wherein the electronic device is further configured to obtain the final gesture from the mapping gesture information and the inertial information, using the extended Kalman filter.

5. The electronic device of claim 4, wherein
the electronic device is further configured to:
obtain the at least one piece of gesture information from the user image, using a pose estimation model,
obtain confidence of the user image from the pose estimation model, and
obtain the final gesture by multiplying a correction weight proportional to the confidence by the Kalman gain of the mapping gesture information, using the extended Kalman filter.

6. The electronic device of claim 1, wherein the electronic device is configured to obtain the inertial information transmitted from the external electronic device in a broadcast manner through the communication interface.

7. The electronic device of claim 6, wherein
a period in which the inertial information is obtained through the communication interface increases at a specified rate, and
the electronic device is further configured to transmit a request signal for requesting the inertial information through the communication interface based on the period being greater than a specified threshold period.

8. The electronic device of claim 1, wherein
the at least one piece of gesture information includes a plurality of sub-gesture information respectively corresponding to a plurality of body regions, and
the electronic device is configured to obtain mapping sub-gesture information corresponding to a specific body region in which the external electronic device is located, from among the plurality of sub-gesture information included in each of the at least one piece of gesture information, based on the at least one piece of gesture information and the inertial information, and
obtain the final gesture of the specific body region of a user corresponding to the mapping sub-gesture information among the at least one user based on the mapping sub-gesture information and the inertial information.

9. The electronic device of claim 8, wherein
the electronic device is further configured to:
select at least one piece of sub-gesture information corresponding to a specified reference body region from among the plurality of sub-gesture information included in each of the at least piece of one gesture information, and
obtain the mapping sub-gesture information corresponding to the specific body region among the selected at least one piece of sub-gesture information included in each of the at least one piece of gesture information, based on the selected at least one piece of sub-gesture information and the inertial information.

10. The electronic device of claim 1, wherein the electronic device is configured to transmit a request signal for requesting the inertial information through the communication interface based on the at least one piece of gesture information including a specified start gesture.

11. A method of operating an electronic device, the method comprising:
obtaining a user image by capturing, through a camera, at least one image of a user using the electronic device;
obtaining at least one piece of gesture information corresponding to each of the at least one user by estimating a gesture from the user image;
obtaining inertial information from an external electronic device through a communication interface;
obtaining mapping gesture information corresponding to the inertial information among the at least one piece of gesture information based on the at least one piece of gesture information and the inertial information; and
obtaining a final gesture for controlling the electronic device of a user corresponding to the mapping gesture information among the at least one user, based on the mapping gesture information and the inertial information.

12. The method of claim 11, wherein
the obtaining of the mapping gesture information includes:
obtaining at least one Kalman gain of the inertial information with respect to each of the at least one piece of gesture information using an extended Kalman filter, and
obtaining gesture information corresponding to a Kalman gain having the largest value among the at least one Kalman gain as the mapping gesture information.

13. The method of claim 12, wherein
the obtaining of the mapping gesture information includes:
obtaining at least one filtering Kalman gain greater than a specified reference value, from among the at least one Kalman gain, and
obtaining gesture information corresponding to a filtering Kalman gain having the largest value among the at least one filtering Kalman gain as the mapping gesture information.

14. The method of claim 12, wherein the obtaining of the final gesture includes obtaining the final gesture from the mapping gesture information and the inertial information using the extended Kalman filter.

15. The method of claim 14, wherein
the obtaining of the at least one piece of gesture information includes:
obtaining the at least one piece of gesture information from the user image using a pose estimation model, and
obtaining confidence of the user image from the pose estimation model, and
the obtaining of the final gesture includes:
obtaining the final gesture by multiplying a correction weight proportional to the confidence by the Kalman gain of the mapping gesture information using the extended Kalman filter.

16. The method of claim 11, wherein,
in the obtaining of the inertial information,
the inertial information transmitted from the external electronic device in a broadcast manner is obtained through the communication interface, and a period in which the inertial information is obtained increases at a specified rate,
the method further comprises:
transmitting a request signal requesting the inertial information through the communication interface based on the period being greater than a specified threshold period.

17. The method of claim 1, wherein
the at least one piece of gesture information includes a plurality of sub-gesture information respectively corresponding to a plurality of body regions,
the method further comprises:
obtaining mapping sub-gesture information corresponding to a specific body region in which the external electronic device is located, from among the plurality of sub-gesture information included in each of the at least one piece of gesture information, based on the at least one piece of gesture information and the inertial information, and
obtaining the final gesture of the specific body region of a user corresponding to the mapping sub-gesture information, from among the at least one user, based on the mapping sub-gesture information and the inertial information.

18. The method of claim 17, further comprising: selecting at least one piece of sub-gesture information corresponding to a specified reference body region from among the plurality of sub-gesture information included in each of the at least one piece of gesture information,
wherein the obtaining of the mapping sub-gesture information includes obtaining the mapping sub-gesture information corresponding to the specific body region from among the selected at least one piece of sub-gesture information included in each of the at least one piece of gesture information, based on the selected at least one piece of sub-gesture information and the inertial information.

19. The method of claim 11, further comprising: transmitting a request signal for requesting the inertial information through the communication interface based on the at least one piece of gesture information including a specified start gesture.

20. A non-transitory computer-readable recording medium having recorded thereon a program which, when executed by at least one processor, comprising processing circuitry, individually and/or collectively, causes an electronic device to perform the method of claim 11.
